(19) United States
(12) Patent Application Publication
(10) Pub. No.: US 2012/0224585 A1
(43) Pub. Date: Sep. 6, 2012

(54) COMMUNICATION METHOD, INFORMATION PROCESSING APPARATUS AND COMPUTER READABLE RECORDING MEDIUM

(75) Inventor: Tsuyoshi HASHIMOTO, Kawasaki (JP)

(73) Assignee: FUJITSU LIMITED, Kawasaki-shi (JP)

(21) Appl. No.: 13/467,377

(22) Filed: May 9, 2012

Related U.S. Application Data
(63) Continuation of application No. PCT/JP2009/069300, filed on Nov. 12, 2009.

(51) Int. Cl. H04L 12/56

(52) U.S. Cl. 370/400

(57) ABSTRACT

A communication method may store by a source node transmission data to be transmitted to destination nodes, create by the source node buffer information to be used by the destination nodes for receiving the transmission data, and transmitting by the source node the buffer information to the destination nodes by a first communication method that makes a multi-destination delivery using a barrier synchronization in which the destination nodes are synchronized by receiving synchronization signals from each of the destination nodes. The method may receive by the destination nodes, respectively, the transmission data using the buffer information by a second communication method that makes a one-to-one communication.

### CROSS-REFERENCE TO RELATED APPLICATIONS

This application is a continuation application filed under 35 U.S.C. 111(a) claiming benefit under 35 U.S.C. 120 and 365(c) of a PCT International Application No. PCT/JP2009/069300, filed on Nov. 12, 2009, the entire contents of which are incorporated herein by reference.

### FIELD

The disclosure relates to a communication method, an information processing apparatus, and a computer readable recording medium.

### BACKGROUND

A method is known in which data transfer is carried out between a host computer system and a network adapter of a transmission method such as the Ethernet (registered trademark), InfiniBand (registered trademark), or the like. In this method, the network adapter reads data from a specific address of a host memory designated by a transmission request message from a device driver of the host computer system.

Further, as a transfer method between processors, in a method called broadcast, when a processor carries out a multi-destination delivery of a message, the multi-destination delivery is unconditionally made to all the processors belonging to a physical subnetwork. Further, a method called multicast is known in which a multi-destination delivery may be made selectively to some of nodes included in a network. In the technical field related to network hardware, the broadcast and the multicast are strictly distinguished from each other in many cases. However, in the technical field related to parallel computing, the broadcast and the multicast may not be clearly distinguished from each other. Further, in some cases, a multi-destination message delivery to all processors logically participating in the communication at a certain point in time, or to all the programs that run on these processors, may also be referred to as a broadcast.

Further, a supercomputer is known in which each of processing nodes mutually connected by independent networks executes a parallel computing in order to carry out parallel algorithm operations. In the parallel supercomputer, a barrier synchronization, that is one type of synchronization process among processing nodes, may be carried out using a global barrier network that is one of the independent networks. The global barrier network refers to a Barrier Network described on page 202, right column, lines 5-23 of A. Gara et al. “Overview of the BlueGene/L system architecture”, IBM J. RES & DEV. VOL. 49 NO. 2/3 MARCH/MAY 2005.

### SUMMARY

It is one object in one embodiment to provide a communication method, an information processing apparatus, and a non-transitory computer readable recording medium, which carries out a broadcast communication from a transmission-source node to a plurality of transmission-destination nodes by positively synchronizing the nodes.

According to one aspect of an embodiment, a communication method includes storing, by a transmission-side node (or transmission-source node), transmission data to be transmitted to a plurality of reception-side nodes (or transmission-destination nodes), in a communication buffer of the transmission-source node; creating, by the transmission-source node, buffer information to be used by the plurality of transmission-destination nodes for receiving the transmission data from the communication buffer; transmitting, by the transmission-source node, the buffer information to the plurality of transmission-destination nodes by a first communication method that makes a multi-destination delivery using a barrier synchronization in which the plurality of transmission-destination nodes are synchronized by receiving synchronization signals from each of the plurality of transmission-destination nodes; and receiving, by the plurality of transmission-destination nodes, respectively, the transmission data from the communication buffer using the buffer information by a second communication method that makes a one-to-one communication (or peer-to-peer communication).

The object and advantages of the invention will be realized and attained by means of the elements and combinations particularly pointed out in the claims.

It is to be understood that both the foregoing general description and the following detailed description are exemplary and explanatory only and are not restrictive of the invention, as claimed.

### BRIEF DESCRIPTION OF DRAWINGS

FIGS. 1A and 1B are flowcharts depicting flows of operations of a communication method according to a first embodiment;

FIGS. 2A and 2B are flowcharts depicting flows of operations of a communication method according to a second embodiment;

FIGS. 3A and 3B are flowcharts depicting flows of operations of the communication method according to the first embodiment;

FIGS. 4A, 4B and 4C illustrate a specific example 1 of the communication method according to the first embodiment;

FIGS. 5A, 5B and 5C illustrate a specific example 2 of the communication method according to the first embodiment;

FIGS. 6A, 6B and 6C illustrate a specific example 3 of the communication method according to the first embodiment;

FIGS. 7A, 7B and 7C illustrate a specific example 4 of the communication method according to the first embodiment;

FIGS. 8A and 8B are flowcharts depicting flows of operations of the communication method according to the second embodiment;

FIGS. 9A and 9B are flowcharts depicting flows of operations of the communication method according to the second embodiment;

FIGS. 10A, 10B and 10C illustrate a specific example 1 of the communication method according to the second embodiment;

FIGS. 11A, 11B and 11C illustrate a specific example 2 of the communication method according to the second embodiment;

FIGS. 12A, 12B and 12C illustrate a specific example 3 of the communication method according to the second embodiment;

FIG. 13 is a block diagram illustrating a hardware configuration example of each node (a transmission-side node, a reception-side node or a relay node) in each of the specific examples of each of the first and second embodiments;

FIG. 14 is a flowchart depicting a flow of operations of a multi-destination delivery (using a barrier synchronization) in each of the first and second embodiments;

FIG. 15 is a flowchart depicting a flow of operations of the barrier synchronization depicted in FIG. 14;

FIG. 16 is a flowchart depicting a flow of operations of a multi-destination delivery (using a reduction apparatus) in each of the first and second embodiments;

FIG. 17 is a flowchart depicting a flow of operations of a method using the reduction apparatus depicted in FIG. 16;

FIG. 18 is a block diagram illustrating the method using the reduction apparatus described in FIGS. 16 and 17;

FIGS. 19, 20, 21, 22A, 22B, 22C, 22D, 22E, 23A and 23B illustrate a method of avoiding contention when a RRDMA function in which a plurality of nodes act as origins is carried out;

FIG. 24 illustrates an example of setting a communication buffer; and

FIG. 25 illustrates an example of a data format of recovery control information.

### DESCRIPTION OF EMBODIMENTS

Preferred embodiments of the present invention will be described with reference to the accompanying drawings.

A communication method according to a first embodiment may utilize a multi-destination delivery method reliable when the data is short, and a reliable one-to-one communication method. In the communication method according to the first embodiment, in particular, a control of distributing buffer information to be described later may be carried out among nodes, by the multi-destination delivery method reliable when the data is short.

A communication method according to a second embodiment may utilize the multi-destination delivery method reliable when the data is short, and a multi-destination delivery method not necessarily reliable when the data is long. In the communication method according to the second embodiment, in particular, the multi-destination delivery method reliable when the data is short may be used for timing control and improving the speed of a transmission error recovery process when carrying out the multi-destination delivery method not necessarily reliable when the data is long.

A communication method may carry out a data communication by appropriately combining the communication method according to the first embodiment and the communication method according to the second embodiment.

The above-mentioned communication methods according to the first and second embodiments may carry out a multi-destination delivery among nodes that carry out parallel computing. As techniques to make a multi-destination delivery in parallel computing, the following three methods 1), 2) and 3) may be employed.

A first method 1) is the most common method. That is, each node uses a reliable one-to-one communication method, transmits data between the nodes according to a certain algorithm, and realizes a multi-destination delivery (for example, see Rajeev Thakur, Rolf Rabenseifner, William Gropp, “Optimization of Collective Communication Operations in MPICH”, International Journal of High Performance Computing Applications, and Kees Verstoep, Koen Langendoen, Henri Bal, “Efficient reliable multicast on Myrinet”, Parallel Processing, 1996, Proceedings of the 1996 International Conference). In order to realize the first method 1), only a communication method that is commonly used is required. Therefore, the costs for the realization the method may be reduced. As techniques related to the first method 1), a technique related to a selection of a relay algorithm exists. Further, a technique exists for improving the speed of the multi-destination delivery for a one-to-one communication in each relay stage, using characteristics of the transmission method of the system. Any one of these techniques has a certain advantage, but a communication delay is at least a product of the logarithm of the number of all the nodes and a delay between the nodes, as long as the first method 1) is used. Further, when using an algorithm which regards as important a constraint related to the bandwidth of the one-to-one communication when carrying out a multi-destination delivery of long data, the communication delay is in proportion to the number of the nodes. In this case, the number of relay destinations is reduced to only one, and all of the bandwidth in the one-to-one communication is used in each relay stage.

The second method 2) uses the multi-destination delivery method not necessarily reliable for data transfer. The number of cases of actually using the second method 2) is smaller than that of the first method 1). According to the second method 2), depending on the particular case, the retransmission using a reliable one-to-one communication method is used for controlling timing in the communication protocol and a recovery for a transmission error (for example, see Katia Obraczka, “Multicast transport protocols: A survey and taxonomy,” IEEE Commun. Mag., vol. 36, no. 1, pp. 94-102, January 1998, and Jiuxing Liu, Amith R Mamidala, Dhabaleswar K Panda, “Fast and Scalable MPI-Level Broadcast using InfiniBand's Hardware Multicast Support”, Technical Report, OSU-CISRC-10/03-TR57, October 2003). In the second method 2), the relay among nodes is not necessary when a data body (the transmission data) is transferred. Therefore, the efficiency is high as long as the transmission error rate in the transmission method is sufficiently small. However, it may be difficult to apply the second method 2) when the number of nodes is large, from a viewpoint of the load to be borne in order to realize, by one-to-one communication, data reception confirmations used during the recovery from the transmission errors.

The number of cases of actually using a third method 3) is also small. According to this third method 3), a buffer is provided in a communication storage dedicated node (that has a multi-destination delivery function) for storing data until a transfer of the data to the next relay point is completed. According to the third method 3), a reliable multi-destination delivery method is realized by confirming the reception through communication between communication relay apparatuses (for example, see Juan Fernandez, Eitan Frachtenberg, Fabrizio Petrini, “BCS-MPI: A New Approach in the System Software Design for Large-Scale Parallel Computers”, Proceedings of the ACM/IEEE SC 2003 Conference (SC 03), the section on “Quadrics”). The communication relay apparatus means, for example, a switch (exchanger) or a router (the same also hereinafter). According to the third method 3), a direct data transfer between nodes is not necessary, and the load of the reception confirmation is small. Therefore, the communication efficiency is high. However, when relaying in a plurality of directions, it is difficult to control the operation states of the buffers when the congestion states in the communication paths in the respective directions are different. Therefore, it may be difficult to realize a multi-destination delivery mechanism according to the third method 3) unless restricting the operation conditions. In many examples, the third method 3) is used only by one specific set of node groups in the same network and all of the node groups are adjacent to each other in the network.

According to the communication methods of the first and second embodiments, it is possible to carry out a multi-destination delivery at a high speed between nodes that carry out parallel computation. In the multi-destination delivery used in parallel computing, the entire computation becomes meaningless when a transmission error occurs even at a part of the data. Therefore, the multi-destination delivery used in the parallel computing is preferably a reliable multi-destination delivery. Further, the data processed in the multi-destination delivery used in the parallel computing has various lengths depending on the contents of computation. For general purposes, in many cases, a communication device that carries out a multi-destination delivery at a high speed may use the following two types of multi-destination delivery methods. The communication device is, for example, a communication card such as a network interface card (NIC) (the same also hereinafter). The first one of the two types of multi-destination delivery methods is the multi-destination delivery method reliable when the data is short. The second one of the two types of multi-destination delivery methods is the multi-destination delivery method not necessarily reliable (there is a likelihood of occurrence of a transmission error) when the data is long. Neither of these two types of multi-destination delivery methods alone may meet the requirements of a multi-destination delivery to be used for the parallel computing.

Therefore, the communication method according to the first embodiment of the present invention uses the multi-destination delivery method reliable when the data is short and a reliable one-to-one communication method. As mentioned above, in the communication method according to the first embodiment, in particular, control of sharing (or distribution of) buffer information to be described later is carried out between nodes that carry out the parallel computing, using the multi-destination delivery reliable when the data is short.

Further, the communication method according to the second embodiment of the present invention uses the multi-destination delivery method reliable when the data is short and the multi-destination delivery method not necessarily reliable when the data is long. In the communication method according to the second embodiment, in particular, the multi-destination delivery method reliable when the data is short is used for timing control and improving the speed of transmission error recovery process at execution of the multi-destination delivery method not necessarily reliable when the data is long.

Further, there may be an embodiment of a communication method of carrying out a multi-destination delivery between nodes that carry out the parallel computing, while appropriately combining the communication method according to the first embodiment and the communication method according to the second embodiment.

Below, significance of “data is short” in the above-mentioned multi-destination delivery method reliable when the data is short will be described. The expression “data is short” is intended to mean that the data that may be transmitted by one operation of a multi-destination delivery that is supported by a used transmission method is shorter than data that is to be transmitted by a multi-destination delivery for the parallel computing. Generally, the more the functions of a transmission method are limited, the easier the functions are implemented as hardware. Therefore, a multi-destination delivery becomes easier to realize with a limitation that limits a target of the multi-destination delivery to a message shorter than a physical packet length at one time, information including only a header part having a fixed length without a message body having a variable length, or the like. That is, a multi-destination delivery of the short data defined by the above-mentioned limitation is easier to realize than a multi-destination delivery of more common information, i.e., information including a message body that has a plurality of physical packets. Therefore, the multi-destination delivery method reliable when the data is short may be significant in that the realization of the multi-destination delivery method reliable when the data is short is easier than the realization of a multi-destination delivery method reliable when the data is long.

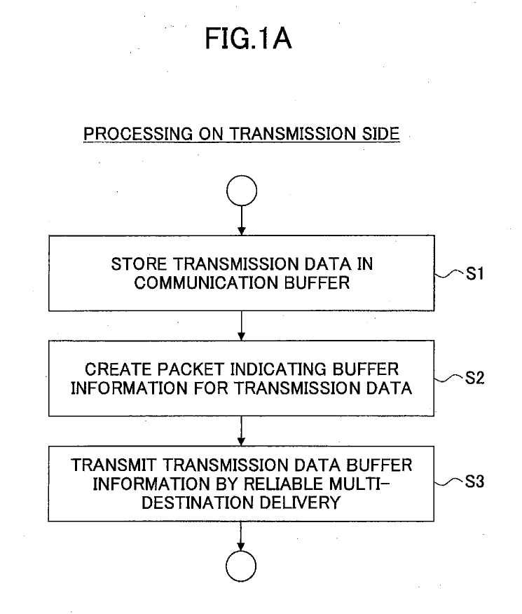

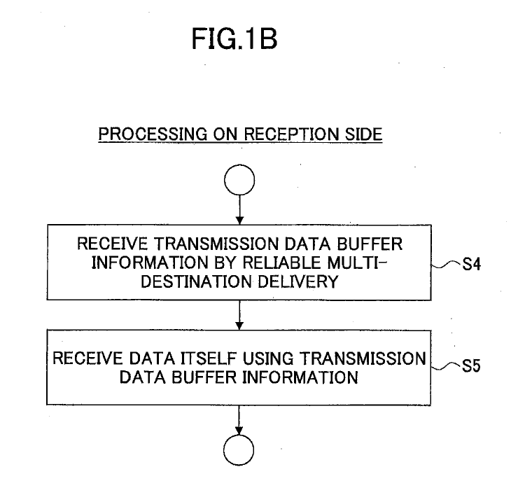

FIGS. 1A and 1B depict a flow of general operations of the communication method according to the first embodiment. In step S1 of FIG. 1A, a transmission-side node (a node on a transmission side, or transmission-source node) stores transmission data in a communication buffer to be described later. In step S2, the transmission-side node creates a packet having buffer information related to the communication buffer. In step S3, the transmission-side node transmits the packet having the buffer information to a plurality of reception-side nodes (nodes on a reception side, or transmission-destination node) using the multi-destination delivery method reliable when the data is short.

In step S4 of FIG. 1B, each of the plurality of reception-side nodes receives the packet having the buffer information transmitted in step S3, using the above-mentioned multi-destination delivery method reliable when the data is short. In step S5, each of the plurality of reception-side nodes accesses the communication buffer using the buffer information that the packet received in step S4 has, and receives the transmission data stored in the communication buffer.

The above-mentioned multi-destination delivery method reliable when the data is short is, for example, a communication method using a barrier synchronization or a reduction apparatus to be described later. Further, a method of accessing the communication buffer and receiving the transmission data stored in the communication buffer in step S5 (i.e., a reliable one-to-one communication method) is, for example, a method using a Read Remote Direct Memory Access (RRDMA) function to be described later.

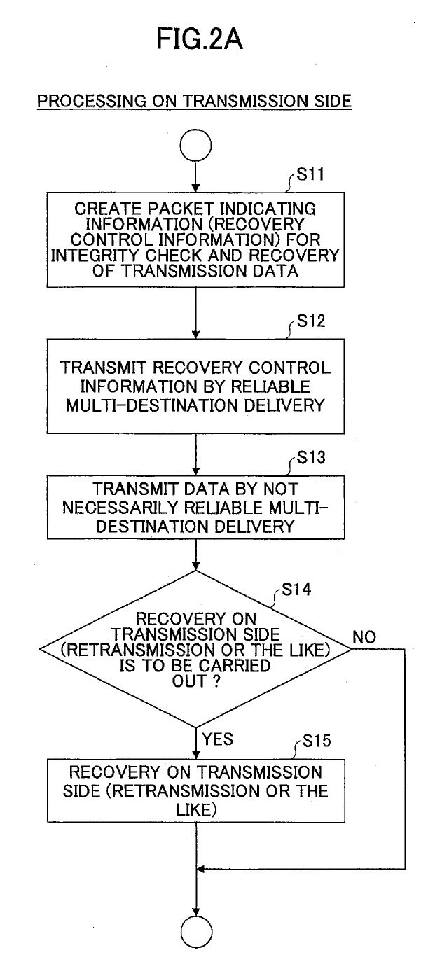

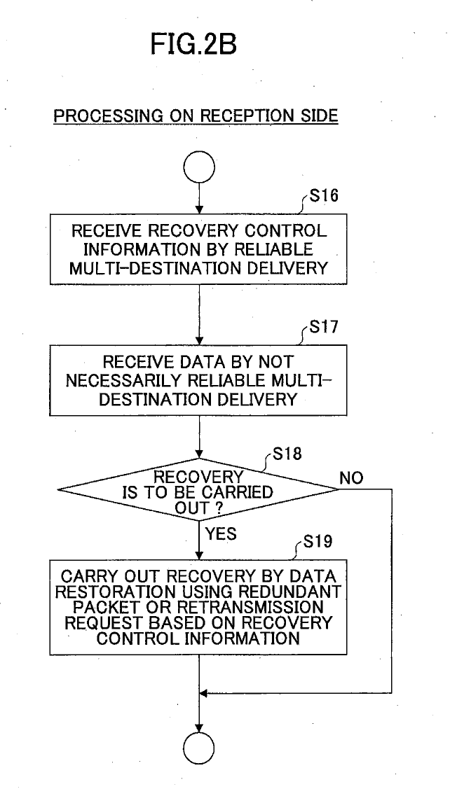

FIGS. 2A and 2B depict a flow of general operations of the communication method according to the second embodiment. In step S11 of FIG. 2A, a transmission-side node creates recovery control information to be used for an integrity check and a recovery of transmission data to be transmitted to the plurality of reception-side nodes. In step S12, the transmission-side node transmits the recovery control information to the plurality of reception-side nodes using the multi-destination delivery method reliable when the data is short. In step S13, the transmission-side node transmits the transmission data to the plurality of reception-side nodes using the multi-destination delivery method not necessarily reliable when the data is long. In step S14, the transmission-side node determines whether a recovery of the transmission data (such as retransmission of the transmission data) is to be carried out. For example, in a case where a retransmission request is transmitted from the reception-side node(s) in step S19 to be described later, the transmission-side node determines that a recovery of the transmission data is to be carried out. Next, in step S15, the transmission-side node carries out the corresponding recovery of the transmission data when having determined that the recovery is to be carried out in step S14, and finishes the operations. The transmission-side node finishes the operations also when having determined that the recovery is not to be carried out in step S14.

In step S16 of FIG. 2B, the plurality of reception-side nodes receive the recovery control information transmitted in step S12, using the above-mentioned multi-destination delivery method reliable when the data is short. In step S17, the plurality of reception-side nodes receive the transmission data transmitted in step S13, using the above-mentioned multi-destination delivery method not necessarily reliable when the data is long. In step S18, the plurality of reception-side nodes carry out integrity checks of the received transmission data using the information to be used for an integrity check of the transmission data included in the recovery control information received in step S16. Then, based on the results of the checks, the plurality of reception-side nodes determine whether recoveries of the transmission data are to be carried out. In a case where a recovery of the transmission data is to be carried out (step S18 YES), the corresponding one(s) of the plurality of reception-side nodes carries out a recovery of the transmission data based on the recovery control information, in step S19, and then, finishes the operations. In a case where a recovery of the transmission data is not to be carried out (step S18 NO), the corresponding one(s) of the plurality of reception-side nodes finishes the operations.

The above-mentioned multi-destination delivery method reliable when the data is short is, the same as above, for example, a communication method using the barrier synchronization or the reduction apparatus to be described later. Further, the above-mentioned multi-destination delivery method not necessarily reliable when the data is long is, for example, a communication method of multicast (the same also hereinafter).

The upper limit of a data length that may be transmitted using the above-mentioned multi-destination delivery method reliable when the data is short is comparatively small. On the other hand, generally, in a communication network to which many nodes are connected, the number of bits expressing the address of each node becomes large. Further, the number of bits of an address indicating a position in a large-capacity storage unit is large. In a case where the above-mentioned upper limit of a data length that may be transmitted is smaller than the size of the above-mentioned buffer information, one of the following methods (a), (b) and (c) or a method combining two or more of the methods (a), (b) and (c) may be used to solve the problem.

(a) The multi-destination delivery method reliable when the data is short is used a plurality of times, and the buffer information is transmitted in a manner of dividing it into a plurality of sets.

(b) As the buffer information, instead of using the address itself of the communication buffer to be used when the communication buffer is accessed for receiving the transmission data, the address itself of the communication buffer is first converted into shorter information, and then, the converted shorter information is transmitted as the buffer information. The conversion is realized by re-encoding of a buffer address, as depicted in the following items (1) through (3).

(1) The number of network addresses of nodes to provide the communication buffers therein is limited to a comparatively small number, and the network addressees are numbered. The thus obtained numbers of the network addresses are not necessarily unique throughout the network, but it is sufficient that the network addresses are unique for a combination of a transmission-side node and a reception-side node, or unique for a combination of a group of transmission-side nodes and a group of reception-side nodes.

(2) The number of addresses in a storage unit in which the communication buffer is provided is limited to a comparatively small number, and the addresses are numbered. Also a method of the numbering is the same as the above item (1), and thus, it is sufficient that the addresses are unique for a combination of a transmission-side node and a reception-side node, or unique for a combination of a group of transmission-side nodes and a group of reception-side nodes.

(3) Correspondence information indicating correspondences between the addresses and the corresponding numbers, determined in the above-mentioned method (1) or (2), is shared by the transmission-side node and the reception-side node, or the group of the transmission-side nodes and the group of the reception-side nodes. When the transmission-side node stores the transmission data in the communication buffer and when the reception-side node starts reception using the RRDMA function, the correspondence information may be used.

(c) In a case where a comparatively large size of the buffer information is transmitted, the buffer information itself is transmitted by the same or similar method as that used for transmitting the transmission data.

The re-encoding of a buffer address (or a preparation of the correspondence information used therefor, i.e., a correspondence table) in the above-mentioned method (b) is carried out at a time of an initial setting of the multi-destination delivery, or before the start of the sequence of the multi-destination delivery operations. Generally, there are many cases where a time period that elapses for looking up in a correspondence table of a memory is one order of magnitude shorter than a time period for carrying out communications between nodes a plurality of times. Further, in many cases, a communication time between nodes becomes longer depending on the data length even when the data length is comparatively short. Therefore, except for an exceptional case where the communication method according to the first embodiment is used for communication carried out for creating the above-mentioned correspondence table to be used for the re-encoding of the buffer address or the like, the method (b) may be advantageous.

On the other hand, in a case where a multi-destination delivery for many nodes is carried out using only a combination of one-to-one communication operations, the number of times of the communication operations increases at least on the order of the logarithm of the number of nodes. Further, in a case where the transmission data has a large size, a delay occurs in proportion to the data length. Therefore, in the case where a multi-destination delivery for many nodes is carried out using only a combination of one-to-one communication operations, a delay occurs which is larger by one order of magnitude than a delay occurring due to an increase in the number of times of communication operations in the above-mentioned method (a), in many cases. Therefore, the method (a) may be advantageous in some cases.

Further, there is a case where the above-mentioned method (c) is advantageous when a large-scale network is used, further a large amount of data is transmitted by a multi-destination delivery, and also, a comparatively large amount of the buffer information is transmitted for the purpose of effectively using the bandwidth of a path in the network. In this case, the advantageous effect of reduction in the communication time period obtainable by the effective use of the bandwidth is larger than the increase in the delay occurring in the case where the buffer information is transmitted by the same or similar method as that of the multi-destination delivery method used for transmitting the transmission data.

Below, the communication method according to the first embodiment will be described in more detail.

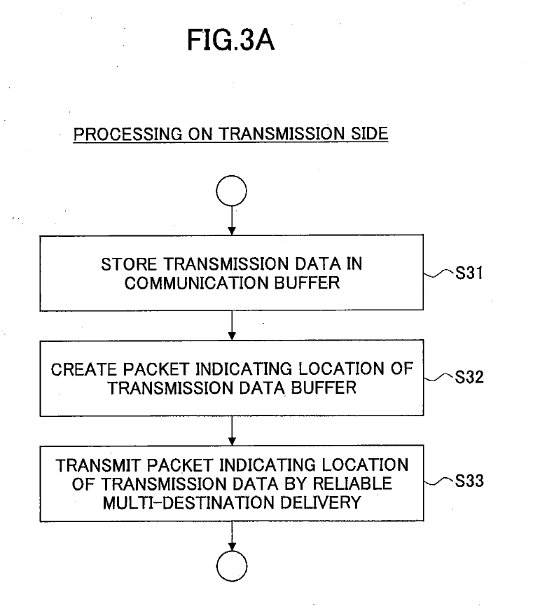

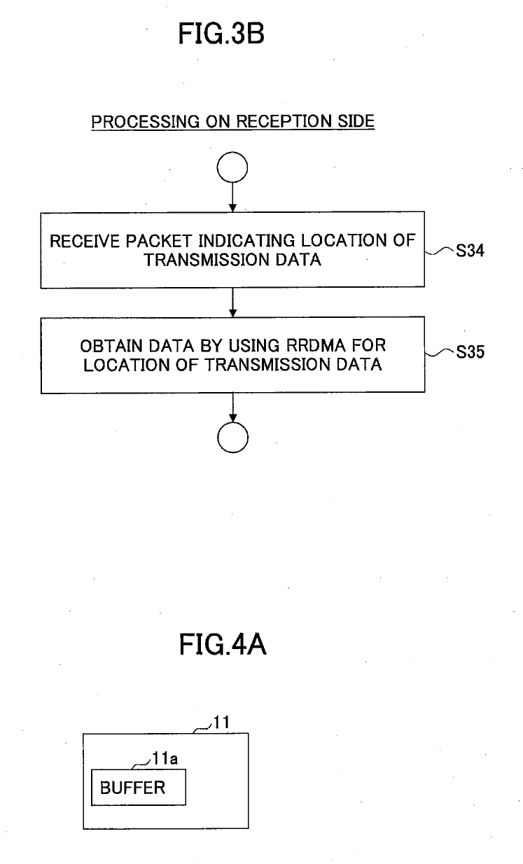

FIGS. 3A and 3B are flowcharts depicting flows of detailed operations of the communication method according to the first embodiment. In FIG. 3A, in step S31, a transmission-side node stores transmission data in a communication buffer. In step S32, the transmission-side node creates a packet including information (buffer information) indicating a location of the communication buffer in which the transmission information is stored. In step S33, the transmission-side node transmits, to plurality of reception-side nodes, the packet including the information (buffer information) indicating the location of the communication buffer, using the multi-destination delivery method reliable when the data is short.

In FIG. 3B, in step S34, the plurality of reception-side nodes receive the packet, including the information (buffer information) indicating the location of the communication buffer, which is transmitted in step S33, using the above-mentioned multi-destination delivery method reliable when the data is short. The plurality of reception-side nodes obtain, using the RRDMA function, the transmission data from the communication buffer, based on the above-mentioned information (buffer information) indicating the location of the communication buffer.

The communication method according to the first embodiment uses the multi-destination delivery method reliable when the data is short and a reliable one-to-one communication method. The reliable one-to-one communication method is, for example, a method using the RRDMA function. By the RRDMA function, the plurality of reception-side nodes can cause the transmission data to be directly transferred to themselves, respectively, from the communication buffer (step S35 in FIG. 3B). A remote direct memory access (RDMA) function in which communication is started from a reception-side node may be called the RRDMA function. The RRDMA function may be referred to as a RDMA Read function or a RDMA Get function. By using the RRDMA function, it is possible to realize a reliable multi-destination delivery that is reliable for various lengths of data used in the parallel computing.

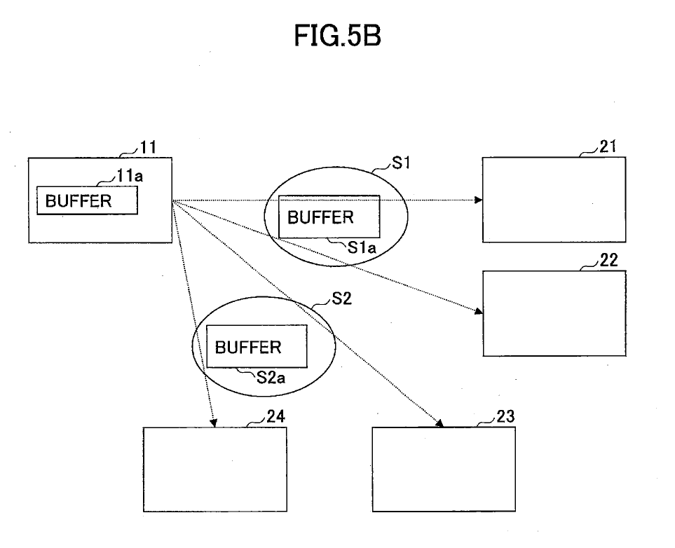

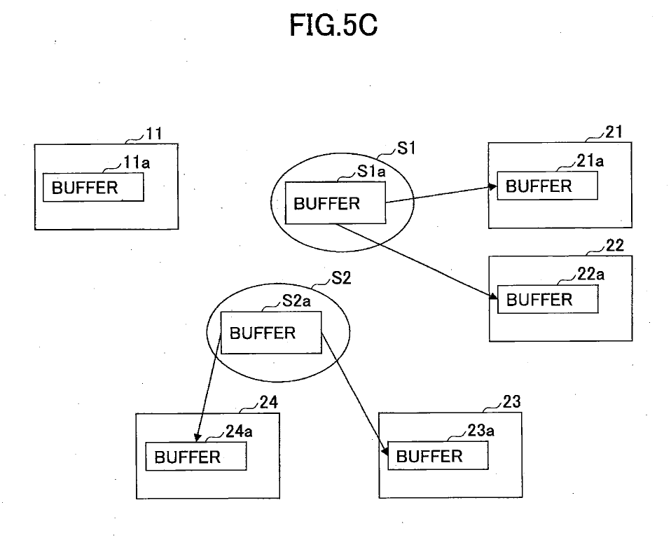

The RDMA function is an accessing function of directly writing a value in a memory of a remote host without using a central processing unit (CPU). By the RDMA function, it is expected that communication may be carried out with a very small delay while the load on the CPU is very small. The RDMA function is defined as a standard function in communication standards such as InfiniBand, Virtual Interface Architecture (VIA), iWarp and so forth. The iWarp may include a function (RDMA over TCP/IP) of carrying out the RDMA function using a TCP/IP connection in Ethernet. Realization of the RDMA function in any one of the standards does not differ therebetween in terms of basic functions (although details of the implementations differ). “RDMA Protocol: Improvement in Network Performance” (URL: http://h50146.www5.hp.com/products/servers/proliant/whitepaper/wp049_{—}060331/pdfs/wp049_{—}060330.pdf), May 14, 2009 describes techniques of the above-mentioned RDMA over TCP/IP and RDMA over InfiniBand. FIG. 2 on page 4 and FIG. 5 on page 9 of “RDMA Protocol: Improvement in Network Performance” (URL: http://h50146.www5.hp.com/products/servers/proliant/whitepaper/wp049_{—}060331/pdfs/wp049_{—}060330.pdf), May 14, 2009 depict flows of data in RDMA.

In step S31 of FIG. 3A, the transmission-side node stores the transmission data in the buffer (the communication buffer) included in a communication device that is included in the transmission-side node. The stored transmission data is information having such a length that the transmission data may be transferred by the RRDMA function and may be stored in the buffer. Further, the communication buffer to store the transmission data is not limited to the buffer in the communication device (that is included in the transmission-side node) but may be a buffer(s) included in a communication relay apparatus in the first relay stage.

After that, the transmission-side node sends the information (buffer information) indicating the location of the communication buffer in which the transmission data is stored, to the plurality of reception-side nodes in steps S33 and S34 using the multi-destination delivery method reliable when the data is short. Alternatively, the information indicating the location of the communication buffer may be previously shared by all the nodes, and information indicating the completion of storing the transmission data in the communication buffer may be sent to the plurality of reception-side nodes. Alternatively, information indicating the status of storing the transmission data in the communication buffer may be sent to the plurality of reception-side nodes. According to the first embodiment, the above-mentioned plurality of reception-side nodes mean all the other nodes included in the network in which the transmission-side node is included. Alternatively, instead of the above-mentioned all the other nodes, the information of the completion of storing the transmission data in the communication buffer or the information indicating the status of storing the transmission data in the communication buffer may be sent to the communication relay apparatus in the first relay stage. In step S35, all the other nodes or the communication relay apparatus in the first stage obtain(s) the transmission data from the communication buffer using the RRDMA function. The communication buffer may be a buffer at a position previously statically determined or a buffer at a position dynamically reported by the transmission-side node or the communication relay apparatus.

The operation of storing the transmission data in the communication buffer in step S31 may generally be realized by the following two methods.

(1) The first method makes an area in a memory (in which the transmission data is stored) accessible from communication devices. There is a case where, for example, the operating system (OS) of the transmission-side node has a paging (a function of temporarily moving a unit of a memory area (page) to a storage area other than the memory). In this case, according to the first method, the storage area in the memory used as the communication buffer is made to continuously exist in the memory during the communication. In other words, the storage area used as the communication buffer is prevented from being selected as a target of the paging.

(2) The second method copies the transmission data to a storage area accessible from communication devices (for example, the above-mentioned storage area in the memory which is prevented from being selected as a target of the paging, a storage area in a memory in a communication card that the transmission-side node has, or the like).

According to the first embodiment, as the communication buffer, a storage unit in the network, from which all the other nodes in the network can obtain the transmission data using the RRDMA function by designating a pair of the address of the storage unit in the network and an address in the storage unit is used. For example, the storage unit at a location such as any one of locations (1), (2) and (3) described below is used as the communication buffer. Alternatively, two or more of the locations (1), (2) and (3) may be combined.

(1) A memory included in the transmission-side node itself or a memory included in a communication card of the transmission-side node.

(2) A memory included in a communication relay apparatus itself or a memory included in a communication card of the communication relay apparatus.

(3) A storage unit included in the network (a memory in a communication relay apparatus or a memory that works with a communication relay apparatus).

An influence due to a difference in the implementation position of the memory used as the communication buffer is limited to a range of the following items (a) through (d).

(a) A difference in the location of the transmission data in the network (the pair of the address of the storage unit in the network and the address in the storage unit) at execution of the RRDMA function used in the communication procedure.

(b) A difference in a command (or a sequence of commands) used for starting the RRDMA function.

(c) A difference in a communication delay depending on the position of implementation of the communication buffer (for example, when a memory in a NIC, a communication device in a communication relay apparatus or the like, is used, a delay time period generated when the transmission data is sent out to the network in general is small in comparison to a case where the memory (main storage) of the transmission-side node is used).

(d) A difference in a capacity depending on the position of implementation of the communication buffer (in general, the capacity of the memory in the communication device is smaller than the capacity of the main storage of the transmission-side node).

For the sake of convenience of explanation, the memories of the above-mentioned items (1), (2) and (3) are not distinguished, and will be simply referred to as communication buffers. Further, although in a large-scale network, a hierarchical relay process including a plurality of relay stages is carried out, only one stage of relay process is described for the case where the relay process is carried out, for the sake of convenience of explanation.

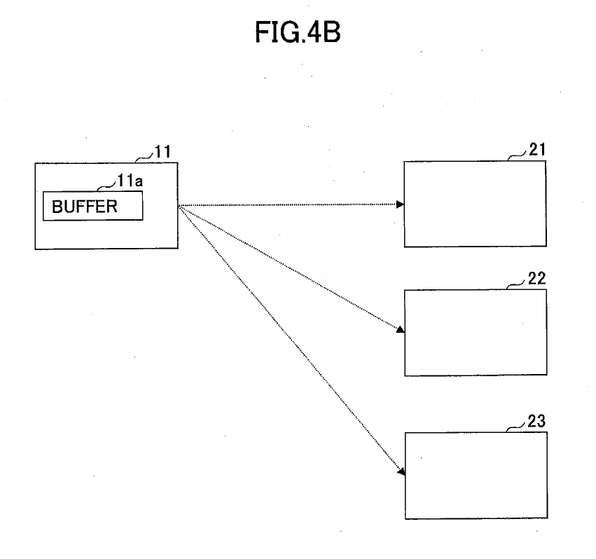

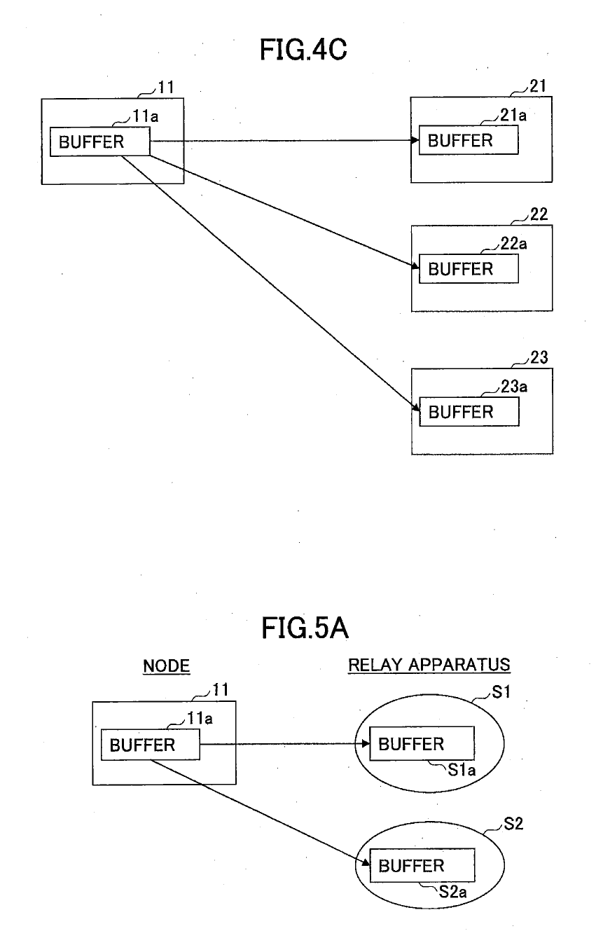

Using FIGS. 4A, 4B and 4C, a specific example 1 of the first embodiment will be described.

The specific example 1 of the first embodiment is a case where the communication buffer is in the transmission-side node, a reliable multi-destination delivery is provided for the transmission data having a common length, using a combination of the multi-destination delivery method reliable when the data is short and the RRDMA function.

First, as depicted in FIG. 4A, the transmission-side node 11 stores the transmission data in the communication buffer 11a. As the communication buffer 11a, the main storage of the transmission-side node 11 may be used, a memory in a communication device that the transmission node 11 has may be used, or a communication device may be connected with a part of the main storage of the transition-side node 11 and the part of the main storage may be used.

Second, as depicted in FIG. 4B, the fact that the transmission data exists in the communication buffer 11a is reported to other nodes 21, 22 and 23 or relay nodes 21, 22 and 23 in the first stage, by the multi-destination delivery method reliable when the data is short.

Third, as depicted in FIG. 4C, the reception-side nodes (all the nodes other than the transmission-side node or the relay nodes in the first stage) 21, 22 and 23 transfer the transmission data stored in the communication buffer 11a to themselves by the RRDMA function. The method using the RRDMA function may be the reliable one-to-one communication method that the reception-side nodes 21, 22 and 23 start.

In a case where the number of relay stages between the transmission-side node 11 and the reception-side nodes 21, 22 and 23 is more than one, the above-mentioned operations of FIGS. 4B and 4C may be repeated, the number of times corresponding to the number of relay stages, while the relay nodes in the preceding stage act as transmission origins.

In the above-mentioned specific example 1 of the first embodiment, the address of the communication buffer in the transmission-side node 11 may previously be transmitted to the reception-side nodes 21, 22 and 23. Then, in the operation of FIG. 4B, the barrier synchronization among a plurality of nodes may be used (or diverted) as the above-mentioned multi-destination delivery method reliable when the data is short. Further, a reception completion notification for the buffer information or the transmission data may be realized also by the barrier synchronization.

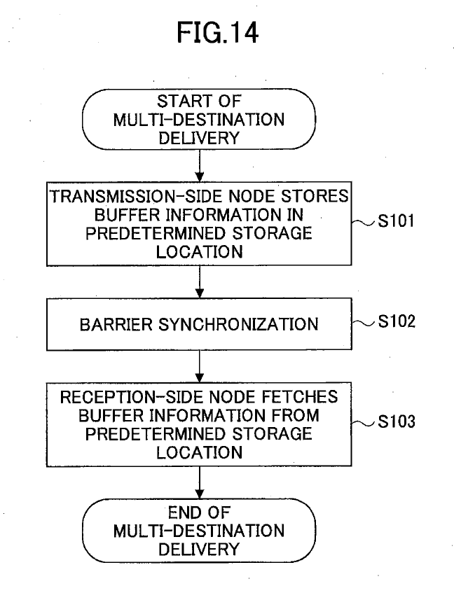

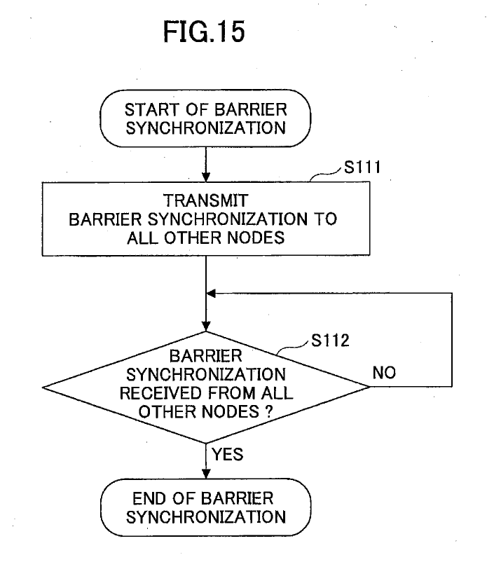

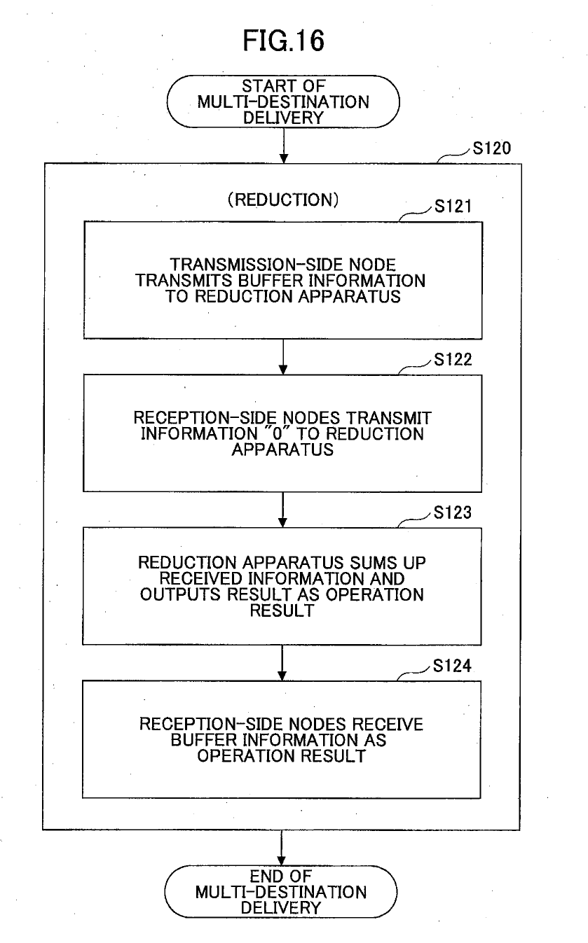

The barrier synchronization is a synchronization method among nodes, in which nodes that participate in the barrier synchronization act as origins of synchronization signals, and the synchronization is completed when the nodes other than the origins receive the synchronization signals from the origins. When the other nodes receive all the synchronization signals from the origins, the relaying may be carried out by nodes other than the nodes acting as the origins. In the barrier synchronization, each of the nodes that participates in the barrier synchronization carries out the synchronous communication with one type of short data called the synchronization signal. The barrier synchronization is often used in a parallel computing system, and therefore, there are many examples of realizing communication systems provided with the barrier synchronization, in particular, in large-scale parallel computing systems. Therefore, an extra cost for applying the barrier synchronization as the multi-destination delivery method reliable when the data is short may be low, in many cases. The barrier synchronization will further be described later with reference to FIGS. 14 and 15. Further, instead of the barrier synchronization, a method using a reduction apparatus, to be described later with reference to FIGS. 16, 17 and 18, may be used.

Next, using FIGS. 5A, 5B and 5C, a specific example 2 of the first embodiment will be described.

The specific example 2 of the first embodiment is a case where a memory of a communication relay apparatus is used as the communication buffer. When a memory that the transmission-side node has is used as the communication buffer in a large-scale network, it is supposed that accessing is concentrated toward the memory of the transmission-side node when the RRDMA function is carried out. In this case, a problem (bottleneck) in the performance of the multi-destination delivery may occur. By using a memory in a communication relay apparatus as mentioned above, this problem may be solved. A method of avoiding a contention that may occur in a case where execution of the RRDMA function is simultaneously requested by many nodes will be described later.

In the specific example 2 of the first embodiment, first, as depicted in FIG. 5A, the transmission-side node 11 stores the transmission data in memories S1a and S2a of communication relay apparatuses S1 and S2, respectively. In a case where only one communication relay apparatus is used for the first relay, one-to-one communication may be carried out. In a case where a plurality of communication relay apparatuses are used even for the first relay, one-to-one communication may be repeated or a multi-destination delivery in the same method as that of the above-mentioned specific example 1 of the first embodiment may be carried out. An advantage of using the memories in the communication relay apparatuses (or memories that work with the communication relay apparatuses) as the communication buffers is as follows. That is, by having stored the transmission data in the buffers of the communication relay apparatuses that exist in the communication paths toward the reception-side nodes, it is possible that the reception-side nodes obtain the transmission data from locations nearer in the network than the transmission-side node, in operations to be described later with reference to FIG. 5C.

Second, as depicted in FIG. 5B, the fact that the transmission data exists in the buffers S1a and S2a in the communication relay apparatuses S1 and S2 is reported to the reception-side nodes (the other nodes or relay nodes) 21, 22, 23 and 24, using the multi-destination delivery method reliable when the data is short.

Third, as depicted in FIG. 5C, the reception-side nodes (the nodes other than the transmission-side node or the relay nodes in the first relay stage) 21, 22, 23 and 24 obtain the transmission data stored in the buffers S1a and S2a using the RRDMA function, respectively. The method using the RRDMA function is the reliable one-to-one communication method started by the reception-side nodes 21, 22, 23 and 24, respectively.

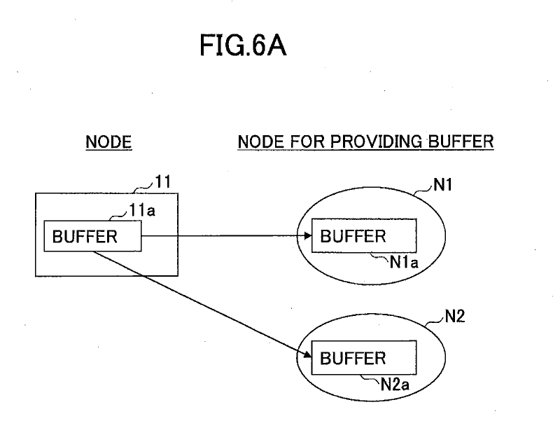

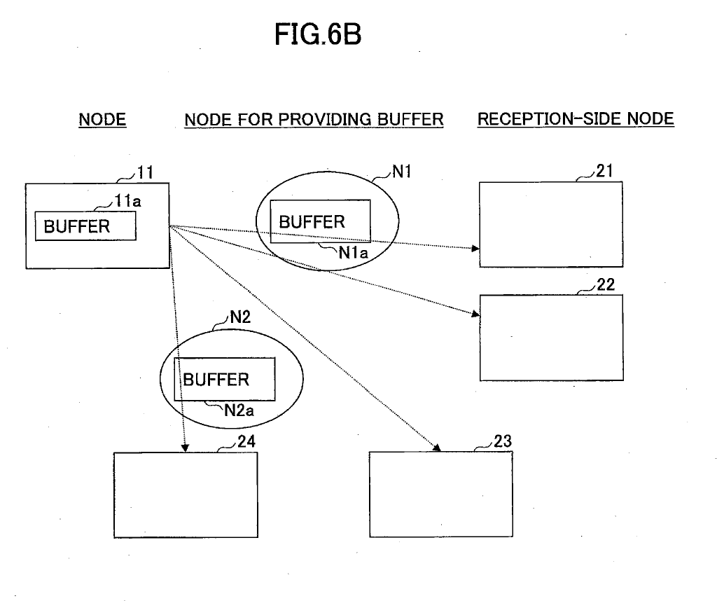

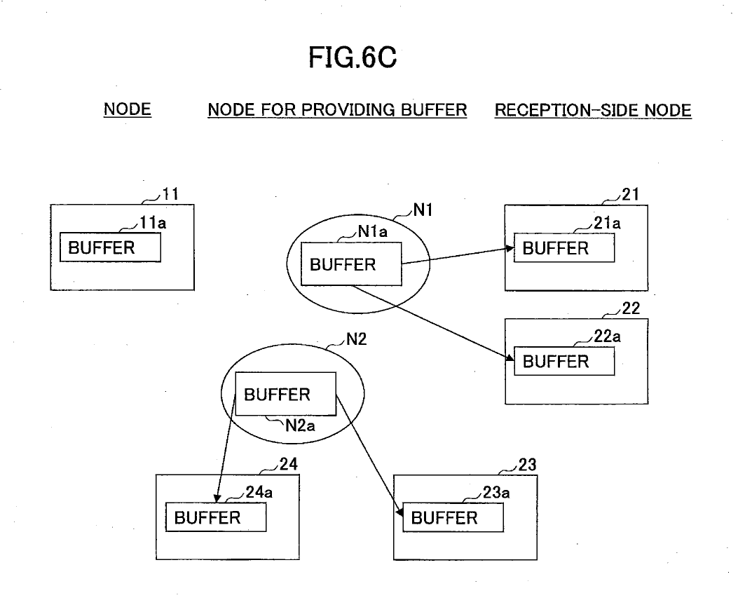

Next, using FIGS. 6A, 6B and 6C, a specific example 3 of the first embodiment will be described.

The specific example 3 is a case where a relay node for providing the communication buffer exists. When a memory that the transmission-side node has is used as the communication buffer in a large-scale network, it is supposed that accessing is concentrated toward the memory of the transmission-side node when the RRDMA function is carried out. In this case, a problem (bottleneck) in the performance of the multi-destination delivery may occur. By using a memory of the relay node for providing the communication buffer, this problem may be solved. A method of avoiding the contention that may occur in a case where execution of the RRDMA function is simultaneously requested from many nodes will be described later.

In the specific example 3 of the first embodiment, first, as depicted in FIG. 6A, the transmission-side node 11 stores the transmission data in memories N1a and N2a of relay nodes N1 and N2 for providing the communication buffers, respectively. In a case where only one relay node for providing the communication buffer is used for the first relay, one-to-one communication may be carried out. In a case where a plurality of relay nodes for providing the communication buffers are used even for the first relay, one-to-one communication may be repeated or a multi-destination delivery in the same method as that of the above-mentioned specific example 1 of the first embodiment may be carried out.

The relay nodes N1 and N2 for providing the communication buffers are selected such that transfer efficiency for the transmission data and load sharing become optimum in consideration of the positions in the network, memory amounts of the relay nodes, the number of interfaces for the network of the relay nodes, and so forth. Unlike the case of using the memories inside of the communication relay apparatuses as in the specific example 2 of the first embodiment described above, it is not necessary for the relay nodes N1 and N2 for providing the communication buffers to exist in the communication paths of one-to-one communication from the transmission-side node to the reception-side nodes.

Second, as depicted in FIG. 6B, the fact that the transmission data exists in the memories N1a and N2a in the relay nodes N1 and N2 for providing the communication buffers is reported to the reception-side nodes (the other nodes or relay nodes) 21, 22, 23 and 24, using the multi-destination delivery method reliable when the data is short.

Third, as depicted in FIG. 6C, the reception-side nodes (the nodes other than the transmission-side node or the relay nodes in the first relay stage) 21, 22, 23 and 24 transfer, to themselves, the transmission data stored on the memories N1a and N2a of the relay nodes N1 and N2 for providing the communication buffers, using the RRDMA function, respectively. The method using the RRDMA function is the reliable one-to-one communication method started by the reception-side nodes 21, 22, 23 and 24, respectively.

In a case where the number of relay stages for the transmission data is more than one, the operations of FIGS. 6A, 6B and 6C may be repeated the number of times corresponding to the number of relay stages while the relay nodes in the preceding stage act as the transmission origins.

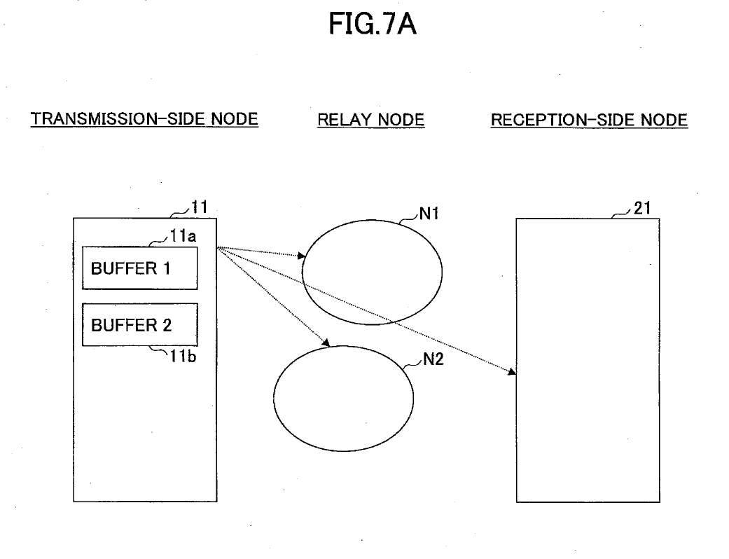

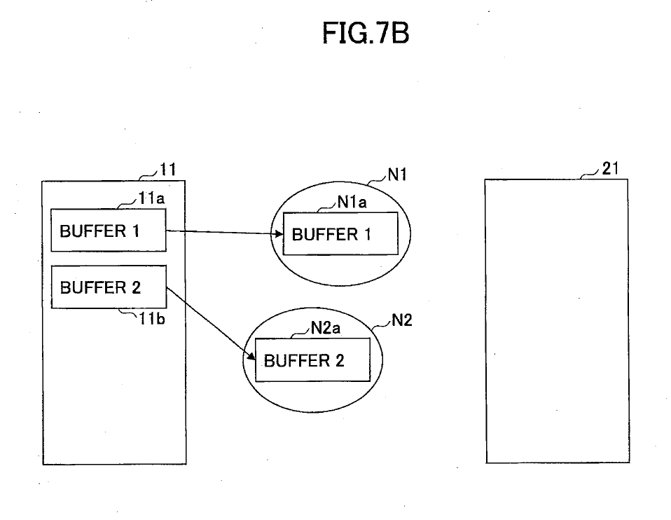

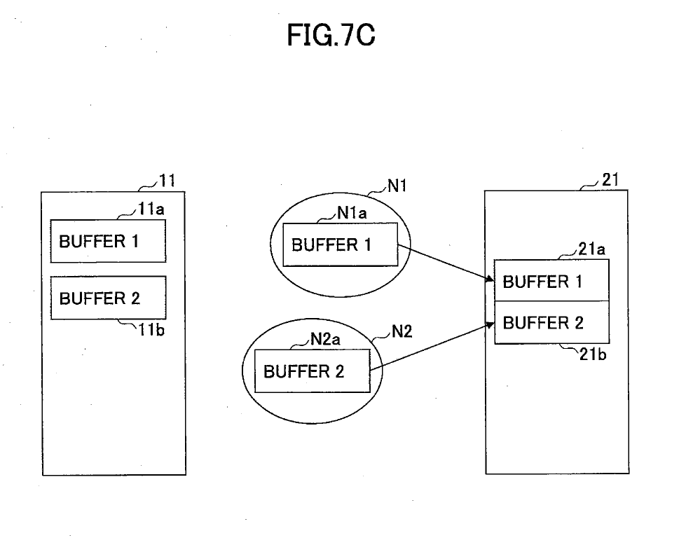

Next, using FIGS. 7A, 7B and 7C, a specific example 4 of the first embodiment will be described.

The specific example 4 of the first embodiment is a case in which, as depicted in FIG. 7A, the transmission-side node 11 uses a plurality of communication buffers 11a and 11b. The specific example 4 of the first embodiment is applied, for example, in the following cases (a) and (b).

(a) A case where a collection of the transmission data exists across the plurality of communication buffers.

In this case, it is possible to omit a copying operation for collecting the collection of the transmission data to a single buffer, according to the specific example 4.

(b) A case where, in order to improve the communication efficiency, a collection of data is transmitted in a manner of dividing the data into a plurality of sets of data.

In this case, (1) it is possible to reduce the delay time occurring at the time of the relay, by reducing the size of data processed by each relay node. Further, (2) it is possible to carry out a plurality of communication operations in parallel, by using a transmission path having a margin in the communication band or by using a plurality of communication paths having independent communication bands in parallel.

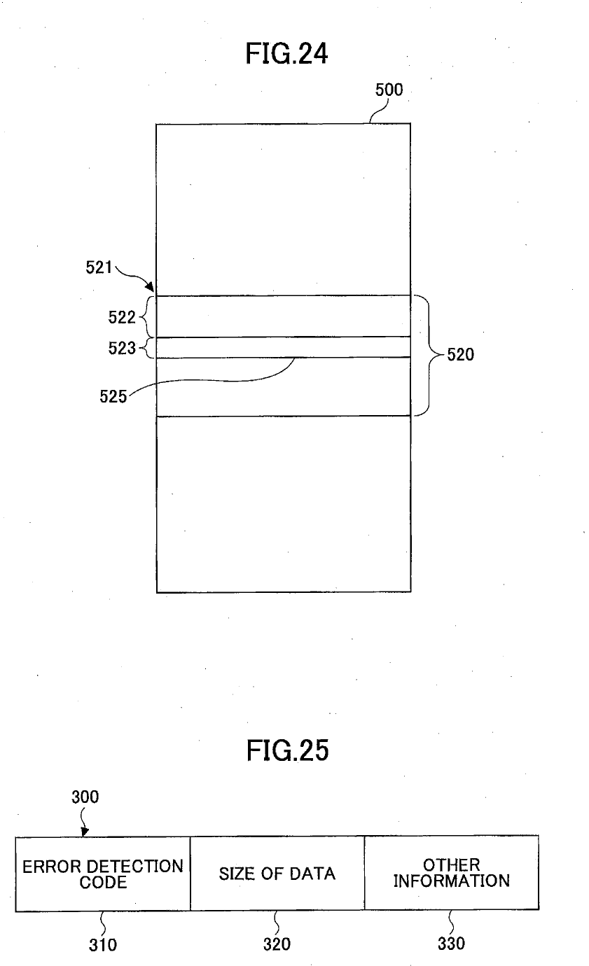

In the above-mentioned case (a) where a collection of the transmission data exists across the plurality of communication buffers, the buffer information generally includes the address and the length of each of the communication buffers, as will be described later with reference to FIG. 24. However, in a case where the continuous data is transmitted in a manner of dividing the data into a plurality of sets of data, or in a case where the offset(s) among the plurality of buffers is (are) fixed, it is sufficient that the buffer information includes the address of the headmost buffer, the data length, and the number of the buffers.

In the specific example 4 of the first embodiment, first, as depicted in FIG. 7A, the buffer information is sent to all of the participating nodes, using the multi-destination delivery method reliable when the data is short.

Second, as depicted in FIG. 7B, the communication relay apparatuses or relay nodes N1 and N2 transfer, to themselves, parts of the transmission data from the communication buffers 11a and 11b, using the RRDMA function, respectively.

Third, as depicted in FIG. 7C, the reception-side node 21 transfers, to memories 21a and 21b of itself, the parts of the transmission data from the memories N1a and N1b of the communication relay apparatuses or relay nodes N1 and N2 using the RRDMA function, respectively. After that, the reception-side node 21 obtains the collection of the transmission data by collecting the parts of the transmission data that are transferred as mentioned above.

Next, the second embodiment of the present invention will be described in more detail.

The communication method according to the second embodiment uses the multi-destination delivery method reliable when the data is short and the multi-destination delivery method not necessarily reliable when the data is long. According to the communication method in the second embodiment, the same as the communication method according to the first embodiment described above, a reliable multi-destination delivery for various lengths of data used in the parallel computing is realized, using the communication method according to the second embodiment.

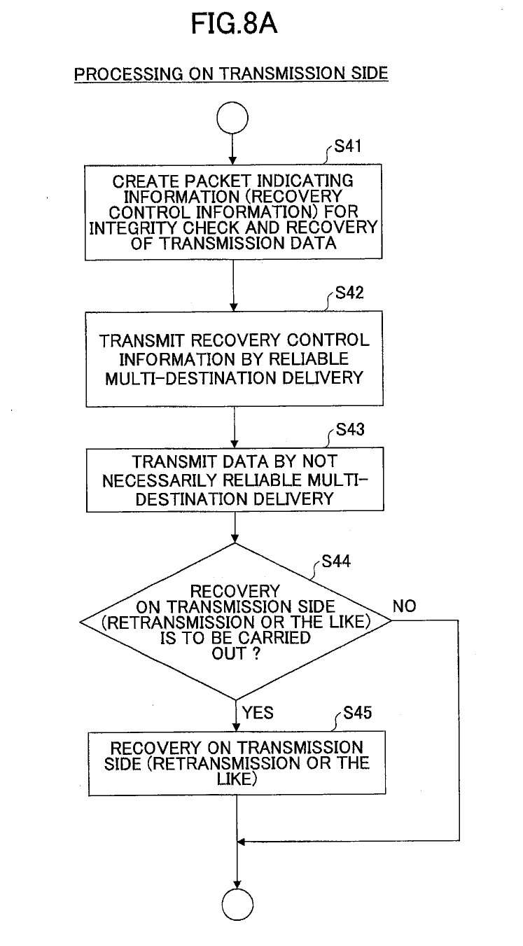

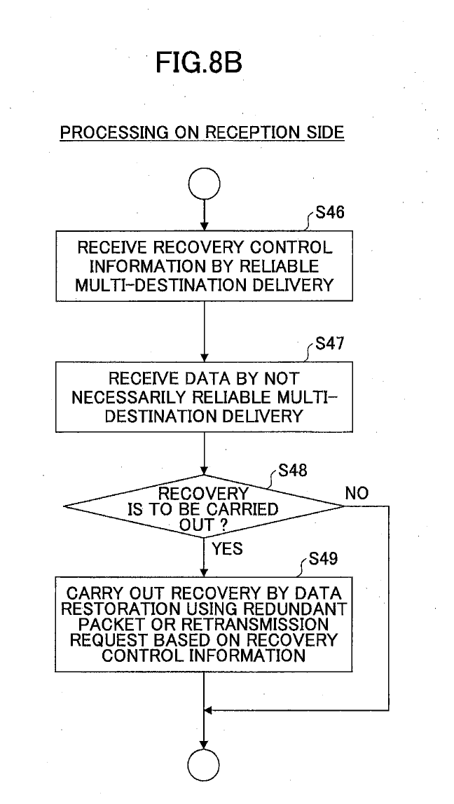

According to the communication method of the second embodiment, as depicted in FIG. 8A, in step S41, a transmission-side node creates recovery control information as information to be used for a transmission error detection and a recovery of the transmission data. The recovery control information includes information indicating the size of the transmission data, an error detection code, and, in some cases, other information such as a timeout period and so forth, as will be described later with reference to FIG. 25. Then, in step S42, the transmission-side node transmits the recovery control information to the reception-side nodes, using the multi-destination delivery method reliable when the data is short. In step S43, the transmission-side node transmits the transmission data to the reception-side nodes, using the multi-destination delivery method not necessarily reliable when the data is long. In step S44, the transmission-side node determines whether a recovery of the transmission data is to be carried out. For example, the transmission-side node determines that a recovery of the transmission data is to be carried out, in a case where the transmission-side node has received a retransmission request(s) for the transmission data from the reception-side node(s). The transmission-side node determines that a recovery of the transmission data is not to be carried out, in a case where the transmission-side node has received no retransmission requests for the transmission data from the reception-side nodes. In a case where determining that a recovery of the transmission data is to be carried out (S44 YES), the transmission-side node carries out a recovery of the transmission data in step S45. Then, the transmission-side node finishes the operations. In a case where determining that a recovery of the transmission data is not to be carried out (S44 NO), the transmission-side node finishes the operations.

Further, as depicted in FIG. 8B, in step S46, the plurality of reception-side nodes receive the recovery control information that is transmitted in step S42, using the above-mentioned multi-destination delivery method reliable when the data is short. In step S47, the plurality of reception-side nodes receive the transmission data that is transmitted in step S43, using the above-mentioned multi-destination delivery method not necessarily reliable when the data is long. In step S48, the plurality of reception-side nodes carry out integrity checks of the received transmission data, using the information to be used for the integrity check of the transmission data (information to be used for a transmission error detection) included in the received recovery control information. In a case where, as a result of the integrity check(s) of the received transmission data, the reception-side node(s) determines that the received transmission data is incomplete, and a recovery of the transmission data is to be carried out (step S48 YES), the corresponding reception-side node(s) carries out a recovery of the transmission data using the information to be used for a recovery included in the received recovery control information, in step S49. Then, the reception-side node(s) finishes the operations. In a case where, as a result of the integrity check(s) of the received transmission data, the reception-side node(s) determines that the received transmission data is complete, and a recovery of the transmission data is not to be carried out (step S48 NO), the corresponding reception-side node(s) finishes the operations.

That is, in step S48, the plurality of reception-side nodes carry out detect transmission errors (if any) of the transmission data received by the multi-destination delivery method not necessarily reliable when the data is long, and carry out recovery process (if it is to be carried out). The detection of transmission errors (if any) of the transmission data received by the multi-destination delivery method not necessarily reliable when the data is long is carried out using the information to be used for the integrity check of the transmission data included in the recovery control information received by the multi-destination delivery method reliable when the data is short.

A specific method of the above-mentioned recovery of transmission data (steps S45 and S49) may generally be classified into the following three methods (a), (b) and (c). The method (c) uses the communication method according to the first embodiment.

(a) Method Using Retransmission:

(1) In a case of having detected a packet abnormality in the transmission data, the reception-side node requests retransmission of the transmission data from the transmission-side node.

(2) In a case of having detected time-out for a reception confirmation response from the reception-side node, the transmission-side node carries out the retransmission of the transmission data.

(b) Method of Giving Redundancy to Transmission Data:

The technique known as Forward Error Correction (FEC) may be used. That is, in a case where the transmission data is transmitted in a manner of dividing into a plurality of packets, the transmission data is transmitted after being converted in such a manner that N+1 packets, for example, will be transmitted according to error correction coding process and the original data may be restored when N packets of the N+1 packets may be properly received.

(c) Method Also Using RRDMA Function (when the RRDMA function is already included in the transmission method to be used):

The buffer information related to the transmission-side node (see the communication method according to the first embodiment described above) is included as a part of the recovery control information as the information to be used for a transmission error detection and a recovery of the transmission data (information to be used for an integrity check and a recovery of the transmission data). Then, in a case where a recovery of the transmission data is to be carried out, the corresponding reception-side node(s) uses the buffer information, and again obtains the transmission data by the RRDMA function using to the communication method according to the first embodiment function.

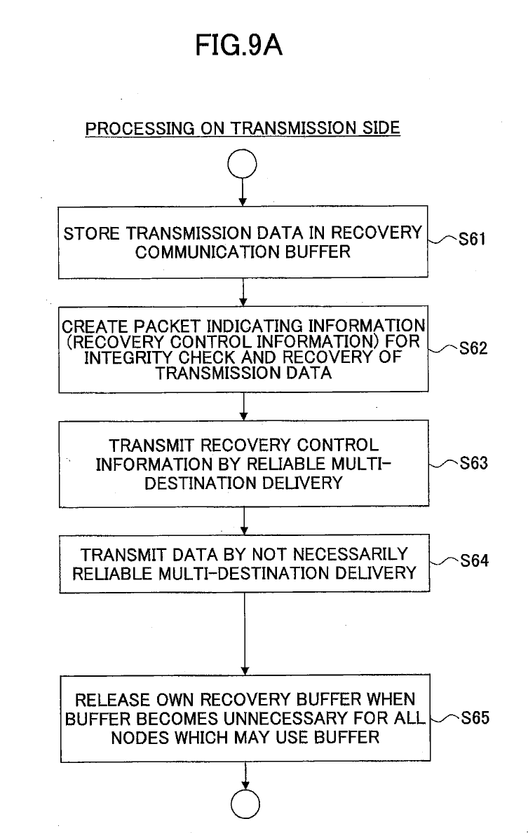

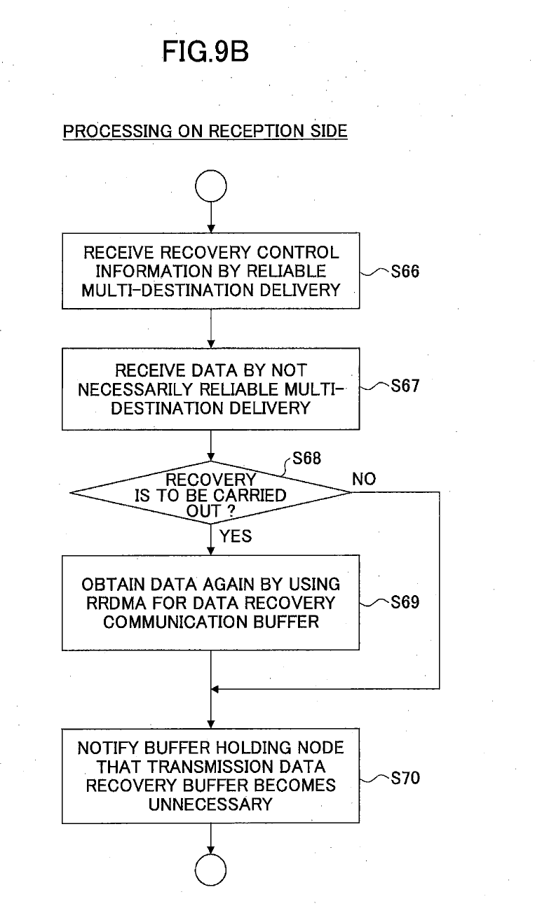

FIGS. 9A and 9B are flowcharts illustrating the communication method according to the second embodiment. However, the method of FIGS. 9A and 9B is an example in which, in the method of FIGS. 8A and 8B, the above-mentioned method (c) is used for the recovery of transmission data.

In step S61 of FIG. 9A, the transmission-side node stores the transmission data in the communication buffer. As to the communication buffer, it is possible to provide the communication buffer by the same method as that used in the communication method according to the first embodiment described above. The same as step S41 in FIG. 8A, the transmission-side node creates the recovery control information as the information for a transmission error detection and a recovery of the transmission data, in step S62. However, in the recovery control information, the buffer information related to the transmission data such as that used in the communication method according to the first embodiment is included. The same as step S42 of FIG. 8A, the transmission-side node transmits the recovery control information to the reception-side nodes using the multi-destination delivery method reliable when the data is short, in step S63. The same as step S43 of FIG. 8A, the transmission-side node transmits the transmission data to the reception-side nodes using the multi-destination delivery method not necessarily reliable when the data is long, in step S64. In step S65, the transmission-side node releases the communication buffer when having received a notification indicating that the communication buffer is not necessary from each of the plurality of reception-side nodes in step S70 to be described later, and finishes the operations.

Further, as depicted in FIG. 9B, the same as step S46 of FIG. 8B, the plurality of reception-side nodes receive the recovery control information transmitted in step S63, using the above-mentioned multi-destination delivery method reliable when the data is short, in step S66. The same as step S47 of FIG. 8B, the plurality of reception-side nodes receive the transmission data that transmitted in step S64, using the above-mentioned multi-destination delivery method not necessarily reliable when the data is long, in step S67. The same as step S48, the plurality of reception-side nodes carry out the integrity check of the received transmission data, using the information to be used for the integrity check of the transmission data included in the received recovery control information, in step S68. In a case where, as a result of the integrity check(s) of the received transmission data, the reception-side node(s) determines that the received transmission data is incomplete, and a recovery of the transmission data is to be carried out (step S68 YES), the corresponding reception-side node(s) uses the communication method according to the first embodiment and obtains the transmission data from the communication buffer of the transmission-side node using the RRDMA function, in step S69. The buffer information included in the received recovery control information is used for thus carrying out the RRDMA function. In step S70, the reception-side node(s) sends the notification that the communication buffer has become unnecessary to the transmission-side node, after the completion of the recovery of the transmission data, and finishes the operations. In a case where the reception-side node(s) determines that a recovery of the transmission data is not to be carried out (step S68 NO), the reception-side node(s) finishes the operations.

According to the communication method of the second embodiment, it is possible that the roles of the following items (1) and (2) of processing that are originally to be carried out by the transmission-side node may be divided among a plurality of nodes, in a large-scale network, in order to distribute the load of the error detection and restoration process (a recovery of transmission data). Further, in a very-large-scale network, it is possible that also the above-mentioned dividing of the process may be performed stepwise (stage by stage) in sequence using the hierarchical relationship for which the transmission-side node acts as an origin and the reception-side nodes act as end points.

(1) A role of receiving of the retransmission request.

(2) A role of holding of the communication buffer for the purpose of the error recovery process (a recovery of the transmission data) using the RRDMA function.

The specific role allocations and the hierarchical relationship related to which nodes carry out recoveries of transmission data for errors that have occurred in which range of nodes for the above-mentioned recovery process (a recovery of transmission data) are determined in consideration of the positional relationship among the nodes (in the network) and the communication efficiency. For example, a hierarchical relationship prepared for a case where a multi-destination delivery is realized by only repetition of one-to-one communication may be used for this purpose. However, different from the case of realizing a multi-destination delivery by only repetition of one-to-one communication, there is not particularly such a constraint that when a recovery of transmission data is to be carried out for the transmission data that a node has received, the preceding node is only one node to support a recovery of the transmission data, in the reception order determined in the algorithm. Any node may receive transmission data approximately at the same time by a multi-destination delivery of a hardware level. Therefore, as a result of the above-mentioned constraint not existing, when a node which could not properly receive transmission data again receives the transmission data, the degree of freedom in selecting a node which provides the transmission data is high.

Specific methods of retransmitting the transmission data for a recovery of the transmission data in a case where an error is detected by the multi-destination delivery method not necessarily reliable when the data is long may include the following two generally classified methods (1) and (2). When the methods are realized in a large-scale network, there are respective problems associated therewith.

(1) Retransmission Using One-to-one Communication:

The method (1) retransmits transmission data to a node which has detected an error. The communication band to be used for the retransmission of the transmission data is small. However, it is necessary to cope with the load that is concentrated on the retransmission source node that needs to make a retransmission request to a node that carries out the retransmission or a notification indicating that the retransmission is unnecessary. Elimination of the load on the transmission-side node is generally realized by creating the hierarchical relationships at the retransmission source. In this case, the delay in the retransmission may easily increase. In a case where a transmission method that is currently used has a reliable one-to-one communication method, it may be efficient to use the reliable one-to-one communication method for the retransmission. It is possible to reduce a probability of an error again occurring from the retransmission to an amount on the order of practically causing no problem (by repeating the retransmission several times, if necessary). Therefore, even in a case where the transmission method itself does not guarantee reliability, it is possible to ensure reliability by the transmission method, using a communication protocol including the retransmission of the transmission data. As to a guarantee of reliability of a transmission method itself, in many cases it is not necessary to specially consider ensuring reliability when using the transmission method because the error detection and the retransmission are controlled as an internal processing of the transmission method.

(2) Retransmission Using Multi-Destination Delivery:

According to the method (2), in a case where a certain node has detected an error, a multi-destination delivery is carried out again. It is possible to prevent an increase in a processing load on the retransmission source by also using a timeout control. However, it may be desirable to cope with the fact that the retransmission of the transmission data uses a large amount of a communication band of the entire network.

Communication errors that may occur from the multi-destination delivery method not necessarily reliable when the data is long, may include the following two types (a) and (b) of errors.

(a) The entire packet does not arrive.

(b) The contents of the packet that has arrived are not correct.

According to the communication method in the second embodiment, the recovery control information is transmitted using the multi-destination delivery method reliable when the data is short. As a result, based on the received recovery control information, a corresponding reception-side node can detect a communication error (for the type (a)), and it is possible to improve the efficiency of recovery of transmission data (for both types (a) and (b)).

Hereinafter, the same as the above description of the communication method according to the first embodiment, differences occurring depending on the implementation position of the communication buffer will not be specially mentioned. Further, in a recovery of transmission data in a large-scale network, there is a case where a number of relay stages of the hierarchical relay process may be carried out. However, for the purpose of easily seeing the drawings, only one stage is described in a case where the relay process is included.

Below, specific examples of the communication method according to the second embodiment will be described using drawings.

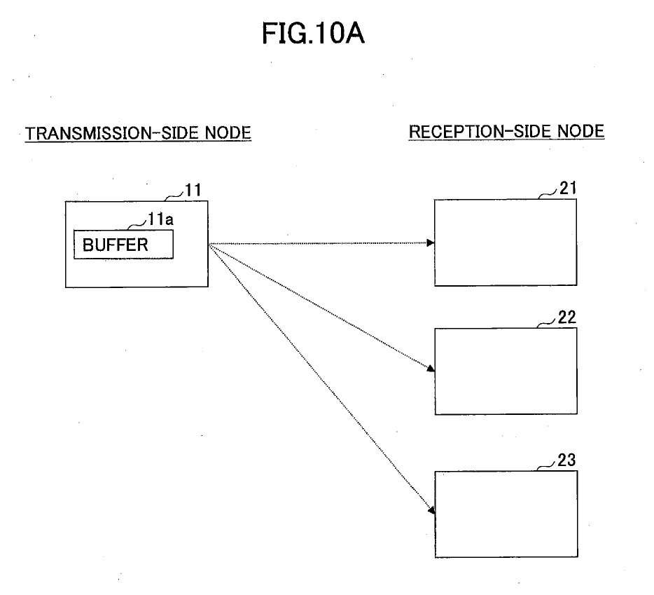

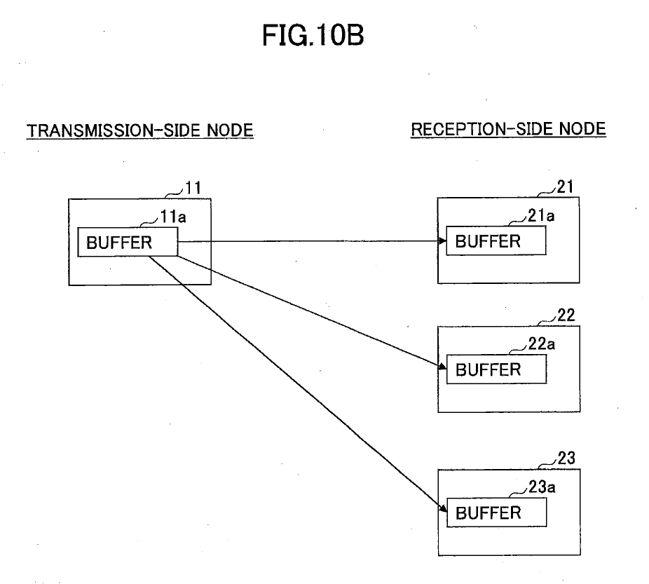

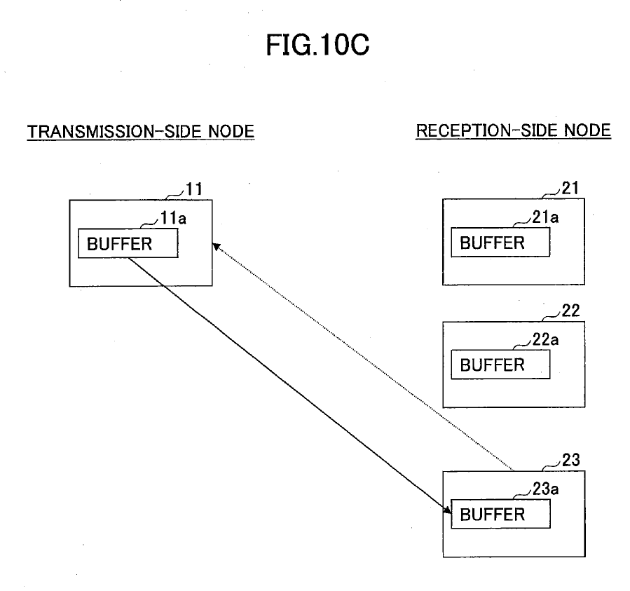

A specific example 1 of the second embodiment will now be described using FIGS. 10A, 10B and 10C.

The specific example 1 of the second embodiment is a basic example for a case where reliability is ensured by a recovery of transmission data using one-to-one communication.

First, as depicted in FIG. 10A, a transmission-side node 11 transmits recovery control information to reception-side nodes 21, 22 and 23 using the multi-destination delivery method reliable when the data is short. The recovery control information is information for a transmission error detection (integrity check) and a recovery of the transmission data, and includes the size of the transmission data, an error detection code, and, in some cases, other information such as a timeout period and so forth (the same also hereinafter).

Second, as depicted in FIG. 10B, the transmission-side node 11 transmits data (transmission data) that is to be sent by a multi-destination delivery to the reception-side nodes 21, 22 and 23, using the multi-destination delivery method not necessarily reliable when the data is long. The reception-side nodes 21, 22 and 23 first carry out error detections for the transmission data based on the above-mentioned recovery control information. The reception-side nodes 21, 22 and 23 finish the operations when no errors are detected as a result of the error detections.

On the other hand, in a case where an error is detected as a result of the error detection in the reception-side node 23, for example, as depicted in FIG. 10C, the corresponding reception-side node 23 carries out a recovery of the transmission data using the recovery control information obtained by the multi-destination delivery method reliable when the data is short.

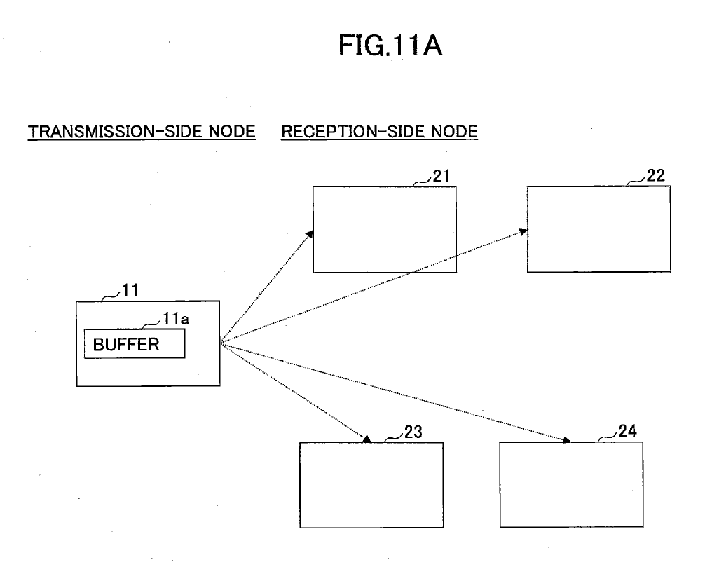

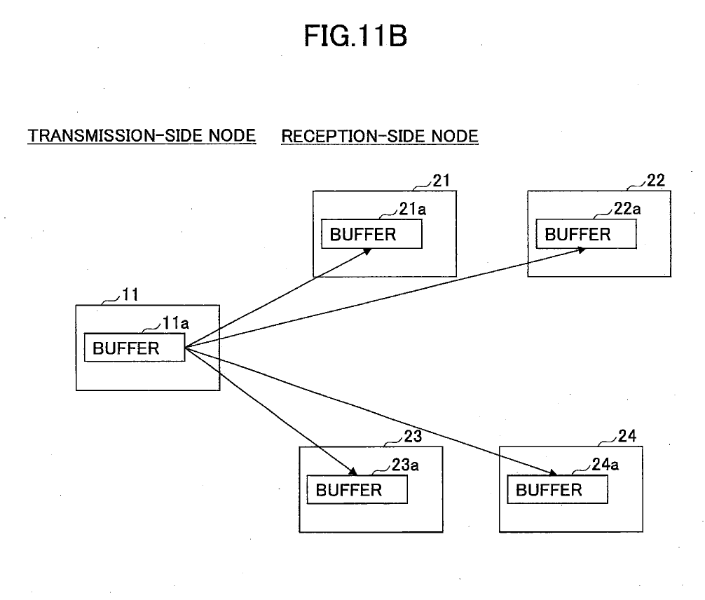

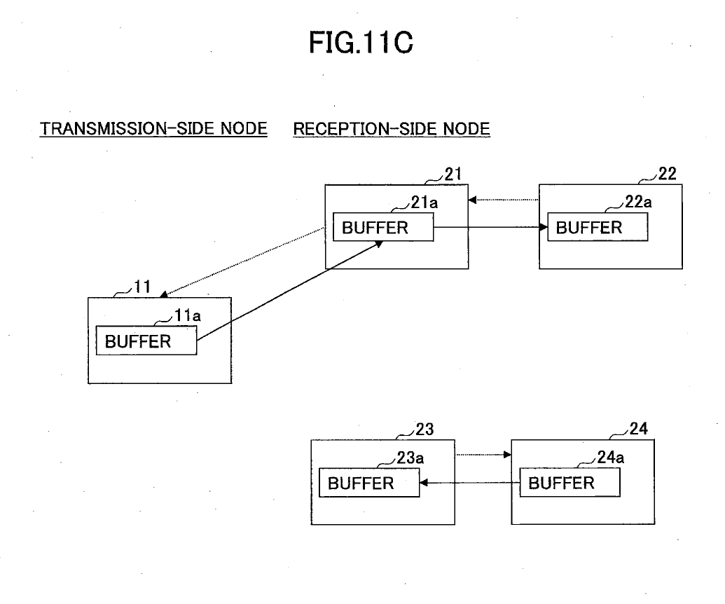

Next, using FIGS. 11A, 11B and 11C, a specific example 2 of the second embodiment will be described. The specific example 2 of the second embodiment is a case in which the load on a transmission-side node when a recovery using one-to-one communication is carried out is distributed (shared).

First, as depicted in FIG. 11A, a transmission-side node 11 transmits recovery control information such as that mentioned above to reception-side nodes 21, 22, 23 and 24, using the multi-destination delivery method reliable when the data is short.

Second, as depicted in FIG. 11B, the transmission-side node 11 transmits data (transmission data) that is to be sent by a multi-destination delivery to the reception-side nodes 21, 22, 23 and 24 using the multi-destination delivery method not necessarily reliable when the data is long. The reception-side nodes 21, 22, 23 and 24 first carry out error detection processes for the received transmission data using information for an error detection included in the above-mentioned recovery control information. The reception-side nodes 21, 22, 23 and 24 finish the operations when no errors are detected as a result of the error detection processes.

In a case where an error is detected as a result of the error detection process in the reception-side node 22, for example, the reception-side node 22 carries out a recovery of the transmission data using information for a recovery included in the received recovery control information. However, different from the specific example 1 of the second embodiment described above, the node 22 carries out a recovery of the received transmission data between the node 22 and the reception-side node 21 other than the node 22, in the specific example 2 of the second embodiment, as depicted in FIG. 11C. In this case, the node 21 acts as a recovery sharing (distributed) node. That is, although the node 22 would carry out a recovery between the node 22 and the transmission-side node 11 according to the specific example 1 of the second embodiment, the node 22 carries out a recovery of the received transmission data between the node 22 and the reception-side node 21 other than the node 22 according to the specific example 2 of the second embodiment. Thus, the load on the transmission-side node 11 at the time of the recovery of the transmission data is shared by the reception-side node 21. In a case where an error is detected also in the transmission data received by the reception-side node 21 related to the recovery load sharing, the node 21 may first carry out a recovery of the transmission data between the node 21 and the transmission-side node 11, as depicted in FIG. 11C, and then, the reception-side node 22 may carry out a recovery of the transmission data between the node 22 and the reception-side node 21.

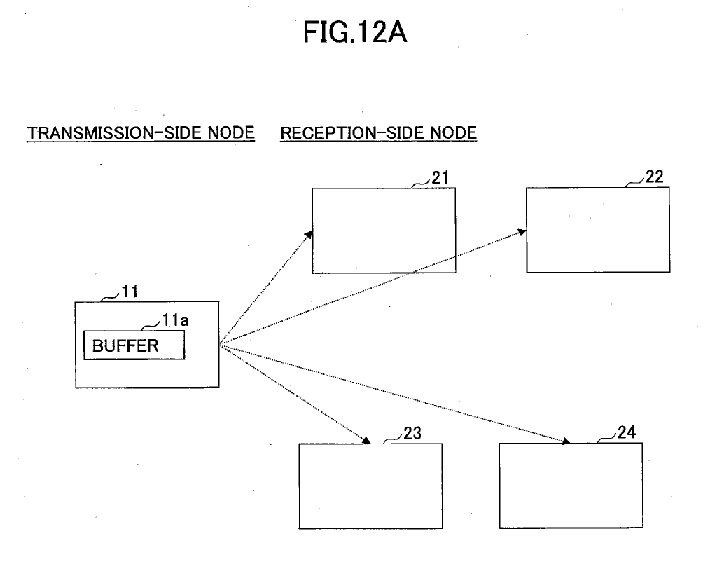

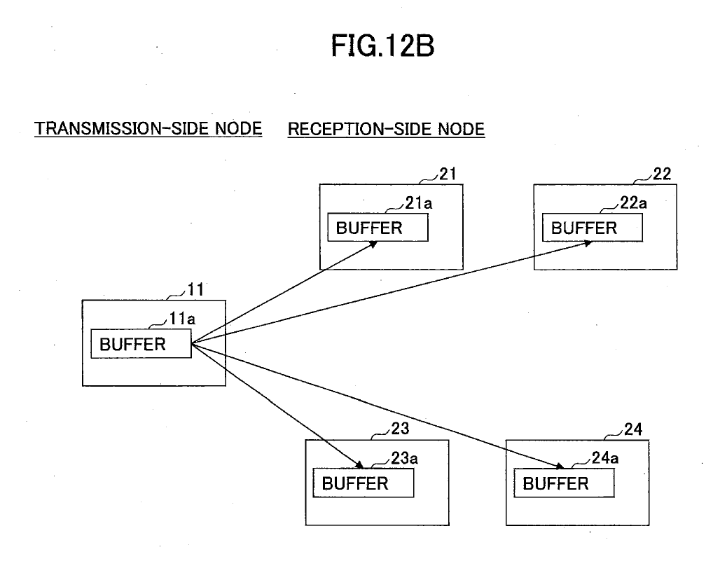

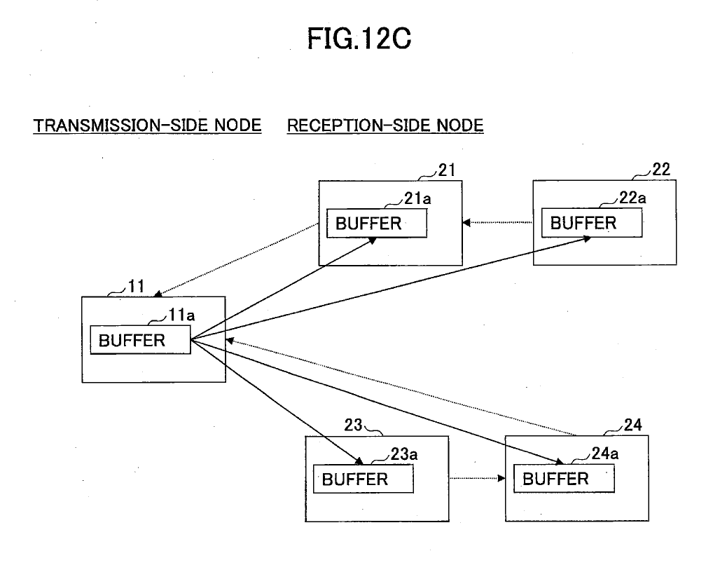

Next, using FIGS. 12A, 12B and 12C, a specific example 3 of the second embodiment will be described. The specific example 3 of the second embodiment is a case in which the load on a transmission-side node at a time of a recovery of transmission data is distributed (shared), and the retransmission is carried out, if necessary, using a multi-destination delivery.

First, as depicted in FIG. 12A, a transmission-side node 11 transmits information for a transmission error detection and a recovery of transmission data (recovery control information) to reception-side nodes 21, 22, 23 and 24, using the multi-destination delivery method reliable when the data is short. The recovery control information includes, the same as above, the size of the transmission data, an error detection code, and, in some cases, other information such as a timeout period and so forth.

Second, as depicted in FIG. 12B, the transmission-side node 11 transmits data (transmission data) that is to be sent by a multi-destination delivery to the reception-side nodes 21, 22, 23 and 24, using the multi-destination delivery method not necessarily reliable when the data is long. The reception-side nodes 21, 22, 23 and 24 first carry out error detection processes for the received transmission data using the information for error detection included in the recovery control information. The reception-side nodes 21, 22, 23 and 24 finish the operations when no errors are detected as a result of the error detection processes.

In a case where an error(s) is detected as a result of the error detection process(es) in the reception-side node(s), the corresponding reception-side node(s) carries out a recovery of the transmission data using the information for a recovery included in the received recovery control information. In the case of the specific example 3 of the second embodiment, the same as the specific example 2 of the second embodiment described above, recoveries of the transmission data are carried out, in sequence, according to the hierarchical relationship, as depicted in FIG. 11C. However, in the case of the specific example 3 of the second embodiment, in a case where a number (exceeding a certain threshold) of retransmission requests (in FIG. 12C, broken arrows) are made from a direction of a low order level in the hierarchical relationship, the retransmission using a multi-destination delivery is carried out (for the nodes on the low order level and those further lower in the hierarchical relationship) (in FIG. 12C, solid arrows). As a result, the delay that may occur due to the relay in the case of FIG. 11C may be reduced. In a case where communication paths are multiplexed, another communication path(s) may be used, in consideration of a likelihood of an abnormality in the communication paths further (in a low order) than a certain level in the hierarchical relationship. For example, in the case of FIG. 12C, according to the given hierarchical relationship, the node 23 makes a retransmission request directly to the node 11. However, in a case where the communication path for the node 11 is multiplexed, the node 23 may use another communication path in which the node 23 makes a retransmission request to the node 11 via the node 24 (broken arrows).

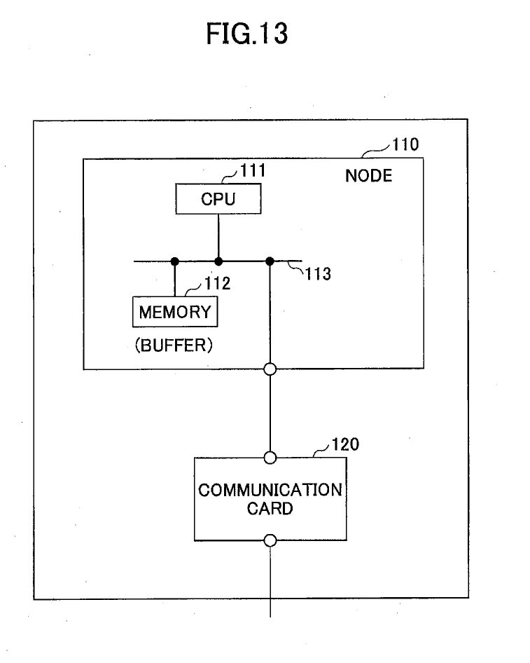

FIG. 13 illustrates a hardware configuration example of nodes, i.e., transmission-side nodes, reception-side nodes and relay nodes, mentioned above, used in the above-mentioned first and second embodiments of the present invention. Each node 110 includes a central processing unit (CPU) 111 and a memory 112, connected via a bus 113. The CPU carries out various sorts of arithmetic and logic operations. In the memory 112, programs executed by the CPU 111 and various sorts of data are stored. The memory 112 is used also as a communication buffer (mentioned above) used in the above-mentioned communication methods according to the first and second embodiments. Further, in the memory 112, programs that realize the communication methods according to the first and second embodiments are stored. Any suitable non-volatile computer readable recording medium, including the memory 112, may store one or more programs. The CPU 111 may carry out the operations described above using FIGS. 1A through 12C or operations to be described later with reference to FIGS. 14 through 25, by executing the programs. Further, the node 110 has a communication card (communication device) 120 to be used when the node 110 carries out communication with another node in the network. The communication card 120 is, for example, a NIC.

FIG. 14 is a flowchart illustrating a flow of operations of the above-mentioned multi-destination delivery method reliable when the data is short (in particular, when using the barrier synchronization). In FIG. 14, in step S101, the transmission-side node stores the buffer information in a certain storage location. Next, in step S102, all the nodes including the transmission-side node and the plurality of reception-side nodes carry out the barrier synchronization to be described later with reference to FIG. 15. Next, in step S103, the reception-side nodes transfer the buffer information stored in the certain storage location to themselves by the RRDMA function. As a result, the plurality of reception-side nodes can obtain the buffer information.

In the method described above using FIG. 14, all the nodes synchronize with each other by the barrier synchronization in step S102. Then, after the synchronization, the reception-side nodes obtain the buffer information from the certain storage location in step S103. Thus, the multi-destination delivery method reliable when the data is short is realized. In the previously performed step S101, the transmission-side node stores the buffer information in the certain storage location. Further, information indicating the certain storage location is previously shared by the above-mentioned all the nodes, the transmission-side node stores the buffer information in the certain storage location at a certain storage timing, and then, the transmission-side node releases the certain storage location at a certain release timing. The barrier synchronization is used as a measure to notify the reception-side nodes of a time period from the above-mentioned certain storage timing to the certain release timing, i.e., a time period during which the buffer information exists in the above-mentioned certain storage location. The transmission-side node may obtain the above-mentioned certain release timing by carrying out the barrier synchronization again after step S103.

FIG. 15 is a flowchart depicting a flow of operations of the barrier synchronization in step S102 of FIG. 14. In FIG. 15, in step S111, the above-mentioned all the nodes transmit barrier synchronization signals to all the other nodes. It is sufficient that the barrier synchronization signals are shortest signals only for the purpose of simply signaling a timing. In step S112, the nodes finish the operations when having received the barrier synchronization signals from all the other nodes (step S112 YES).

With regard to the barrier synchronization, page 13 of “Concurrency: Mutual exclusion and synchronization” (URL: http://www.cs.helsinki.fi/u/alanko/rio/S02/kalvokopiot/ch3_p2.pdf), May 14, 2009 depicts diagrams from the viewpoint of how to write a program. Further, pages 9 through 15 of “Barrier Synchronization”, Maurice Herlihy & Nir Shavit (URL: http://www.cs.brown.edu/courses/cs176/ch17.ppt), May 14, 2009 discusses a concept of the barrier synchronization. In particular, in “Concurrency: Mutual exclusion and synchronization” (URL: http://www.cs.helsinki.fi/u/alanko/rio/S02/kalvokopiot/ch3_p2.pdf), May 14, 2009, the following point is described. That is, until all the threads (threads: individual process flows in parallel process) have passed through a certain processing block (in other words, until all the threads have reached a point immediately before the next process), no thread proceeds to the next process block.

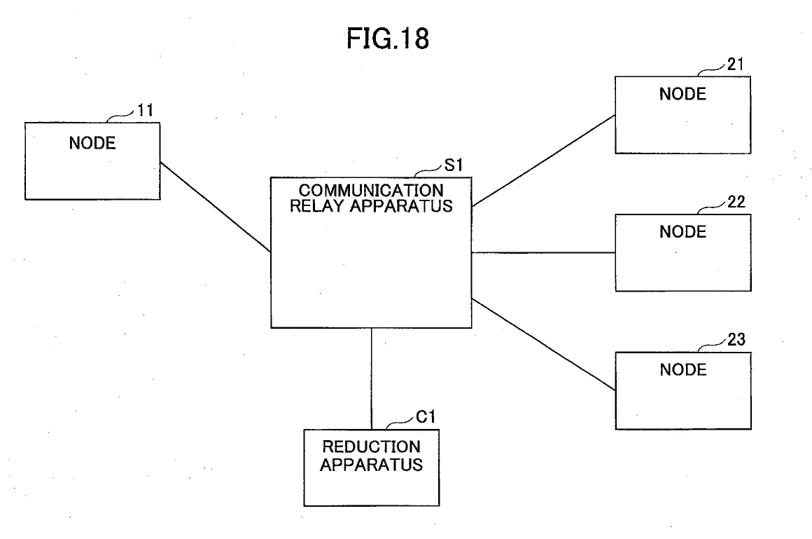

FIG. 16 is a flowchart illustrating a flow of operations of the above-mentioned multi-destination delivery method reliable when the data is short (in particular, in a case using a reduction apparatus). In FIG. 16, in step S120, all the nodes including the transmission-side node and the plurality of reception-side nodes use a reduction apparatus, and carry out operations of steps S121, S122, S123 and S124. The reduction apparatus will be described later with reference to FIG. 18.

In step S121, the transmission-side node transmits the buffer information to the reduction apparatus. In step S122, the plurality of reception-side nodes transmit information “0” to the reduction apparatus. In step S123, the reduction apparatus carries out a summation operation of the buffer information received in step S121 and the information “0” received in step S122. As a result of the summation operation, i.e., “buffer information”+“0”+“0”+“0”+“buffer information”, the buffer information is obtained as the operation result. The reduction apparatus transmits the operation result to all the nodes. As a result, in step S124, the plurality of reception-side nodes can obtain the buffer information as the operation result. Thus, the multi-destination delivery method reliable when the data is short is realized.

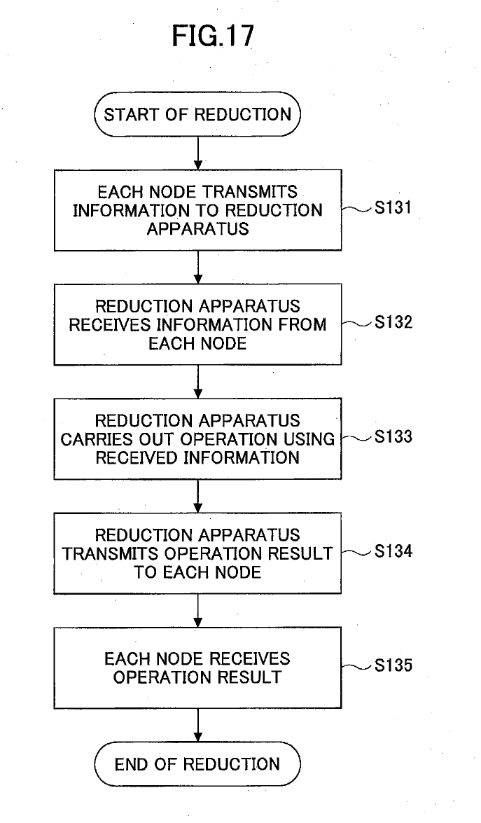

FIG. 17 is a flowchart illustrating, from viewpoint other than FIG. 16, the flow of operations of the multi-destination delivery method reliable when the data is short, using the reduction apparatus, of step S120 of FIG. 16. In FIG. 17, in step S131 (corresponding to steps S121, S122 in FIG. 16), the nodes transmit information to the reduction apparatus. In step S132 (corresponding to step S123), the reduction apparatus receives the information transmitted by the nodes. In step S133 (corresponding to step S123), the reduction apparatus carries out an operation (for example, the above-mentioned summation operation) based on the received information. In step S134 (corresponding to step S123), the reduction apparatus transmits the result of the above-mentioned operation to the nodes. In step S135 (corresponding to step S124), the nodes receive the result of the operation.

FIG. 18 is a block diagram illustrating the above-mentioned reduction apparatus (see FIGS. 16 and 17). The reduction apparatus Cl is connected with the communication nodes 11, 21, 22 and 23 via a communication relay apparatus S1 in the network. The reduction apparatus C1 has a hardware configuration the same as that of the nodes described above using FIG. 13, for example. As mentioned above, the reduction apparatus C1 receives information from all the nodes 11, 21, 22 and 23 (step S132 of FIG. 17), carries out a certain operation (for example, a summation operation, as mentioned above) (step S133 of FIG. 17), and transmits the result of the operation to all the nodes 11, 21, 22 and 23 (step S134 of FIG. 17).

“Development of High Function, High Performance System Interconnect Technology”, Kyushu University/Fujitsu Limited, Hiroaki Ishihata (URL: http://www.psi-project.jp/images/event/hiroakiishihata_{—}20061220.pdf), May 14, 2009, “Development of High Performance Switch Supporting Collective Communication”, Fujitsu Limited, Shimizu Toshiyuki (URL: http://www.psi-project.jp/images/event/toshiyuki_shimizu_{—}20080218.pdf), May 14, 2009, and Fujitsu Forum 2008, “Advanced Technology Taking Role of Petascale Computing” (URL: http://forum.fujitsu. com/2008/tokyo/exhibition/downloads/pdf/technology02_panf_jp.pdf), May 14, 2009 discuss the reduction apparatuses. In “Development of High Function, High Performance System Interconnect Technology”, and “Development of High Performance Switch Supporting Collective Communication”, the term collective communication may be used only to refer to a reduction. However, operations of “MPI_Allreduce” that is a function for the reduction may include an operation of the barrier synchronization in a calculation process (for the purpose of calculating a value, the synchronization process is carried out consequently). Therefore, there are cases where the collective communication indicates both the reduction and the barrier synchronization. Fujitsu Forum 2008, “Advanced Technology Taking Role of Petascale Computing” discusses a role of a reduction apparatus in improving the speed of the parallel computing. A high performance switch may realize an operation of the “MPI_Allreduce” that is the function for the collective communication of the MPI by hardware. By using the “MPI_Allreduce”, it is possible to obtain a value calculated from input data that all the nodes have, for example, the sum as an output of the function. Therefore, as a result of all the other nodes (than a node that transmits data) calling the “MPI_Allreduce” while designating “0”, a multi-destination delivery of the data is realized for the data that has such a size that the data may be regarded as a numerical value.

Next, a method of avoiding the contention that may occur in a case where execution of the RRDMA function is requested by many nodes simultaneously will be described.

As to the method of avoiding the contention, first, a general description will be made.

(1) In order to clarify the problem, the contention is defined as a situation in which simultaneously accessing one node by the RRDMA function from a plurality of nodes consequently does not result in improvement of multi-designation deliver performance.

Accessing data of a certain node by a plurality of nodes using the RRDMA function itself is possible, as a matter of course, as long as a transmission method that is currently used supports a network including three or more nodes. Generally, simultaneous access to certain hardware is processed in a manner of time sharing using an arbitration function in the hardware or exclusive control by the associated software.

Therefore, as a problem, a case may be considered where expected performance improvement effect cannot be obtained. Generally, such a problem related to the performance is understandable as being caused by the load on an element of a transmission method exceeding a previously expected value or amount.

(2) Methods of dealing with the problem described at the end of the immediately preceding item (1), caused by the load on an element of a transmission method exceeding a previously expected value or amount, may be considered to generally include the following two methods (a principle of controlling the load on the element of the transmission method to be within an expected range is common between the two methods).

The first dealing-with method prepares a resource corresponding to the expected load. For example, in a case where it is supposed that the load on a NIC is large, a NIC having higher capability is prepared, or a plurality of NICs are prepared, according to the first dealing-with method.

The second dealing-with method adjusts the load to meet the amount of communication resources that may be prepared. For example, in a case where it is supposed that the load on a NIC is large, the number or the amount of transfer requests given to the NIC at a time is controlled. For example, a case is assumed where for a transfer request for data having a specific size, a capability of a prepared NIC is such that the number of the requests which, when being processed simultaneously, does not result in a serious reduction of the performance is 6 or less. In this case, a configuration may be provided such that data transfer is carried out hierarchically, and the number of transfers is controlled to be only 6 or less simultaneously on one level of the hierarchy. In this case, such a configuration may be provided that the number of notification destinations using the multi-destination delivery reliable when the data is short is controlled to be 6 or less per one level in the hierarchy.

As described above, the methods of avoiding the contention conclude with the following two methods (a) and (b).

(a) According to this method (a), the load on a communication resource in each node is properly estimated, and the resource corresponding to the load is papered.

(b) According to this method (b), load distribution to the resources is properly adjusted in order to effectively use prepared resources.

In the communication methods using combinations of the multi-destination delivery method reliable when the data is short and the reliable one-to-one communication method using the RRDMA function in each of the above-mentioned first and second embodiments, the following method is carried out, for example. That is, when the buffer information or the recovery control information is transmitted using the multi-destination delivery method reliable when the data is short, information related to load sharing (load distribution) is also transmitted. As a result, the above-mentioned method (b) may be effectively carried out. Further, as to the above-mentioned method (a), by previously storing (preparing) system resources assuming that each of the first and second embodiments is applied, it may be expected that the performance improvement effect in each embodiment is further increased.

Below, the methods of avoiding the contention that may occur in a case where requests for carrying out the RRDMA function are made from a plurality of nodes simultaneously will be described more specifically.

By using the RRDMA function initiated from the reception-side nodes, it is possible to avoid the problem of the load on the CPU in the transmission-side node being in proportion to the number of transmission destinations. However, also the loads on the resources (the memory, the NIC, the bus and so forth) other than the CPU in the transmission-side node increase in proportion to the number of transmission destinations. Therefore, in a case where the number of transmission destinations is large, there may be a problem of the loads on the resources other than the CPU becoming a bottleneck due to simultaneous accessing or overlap (contention) of access timings from the many transmission destinations related to the RRDMA function, which problem is to be avoided. Methods of avoiding the contention of accessing the resources may generally be classified into the following two methods (a) and (b).

(a) As to a system resource having a too heavy load, the number thereof per node is increased, and the increased resources are operated in parallel. Specifically, the following methods (1), (2) and (3) may be considered.

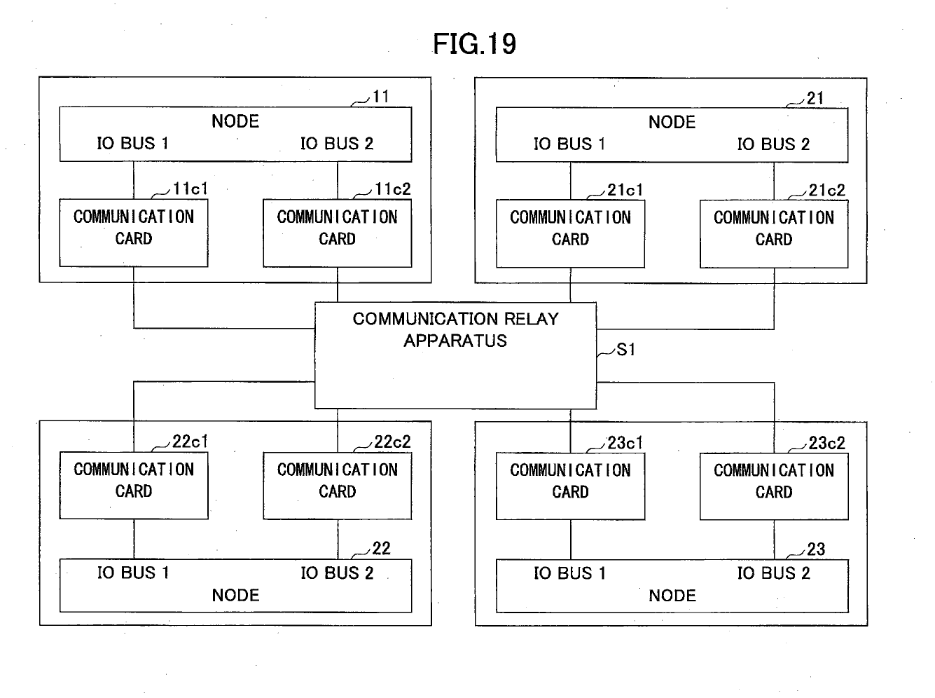

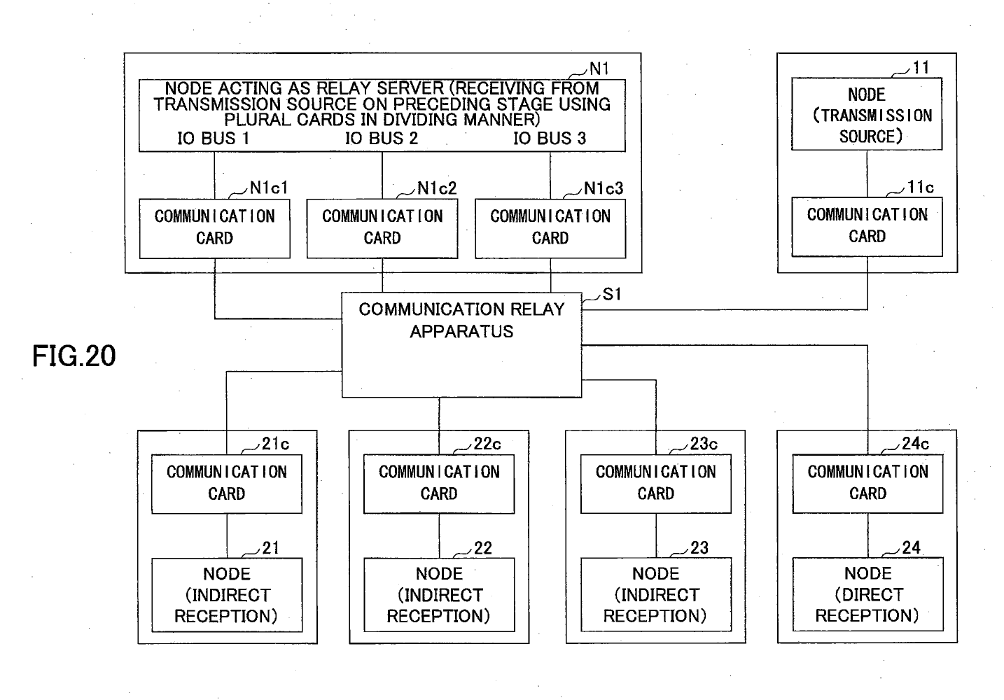

(1) In a case where the load on a NIC is a bottleneck, a plurality of NICs are provided for 1 system, and are operated in parallel as will be described later with reference to FIGS. 19 and 20.

(2) In a case where accessing a memory bus or accessing an IO bus is a bottleneck, the number of the buses, or the number of accessing operations that may be processed by one bus simultaneously is increased, as will be described later with reference to FIGS. 19 and 20.

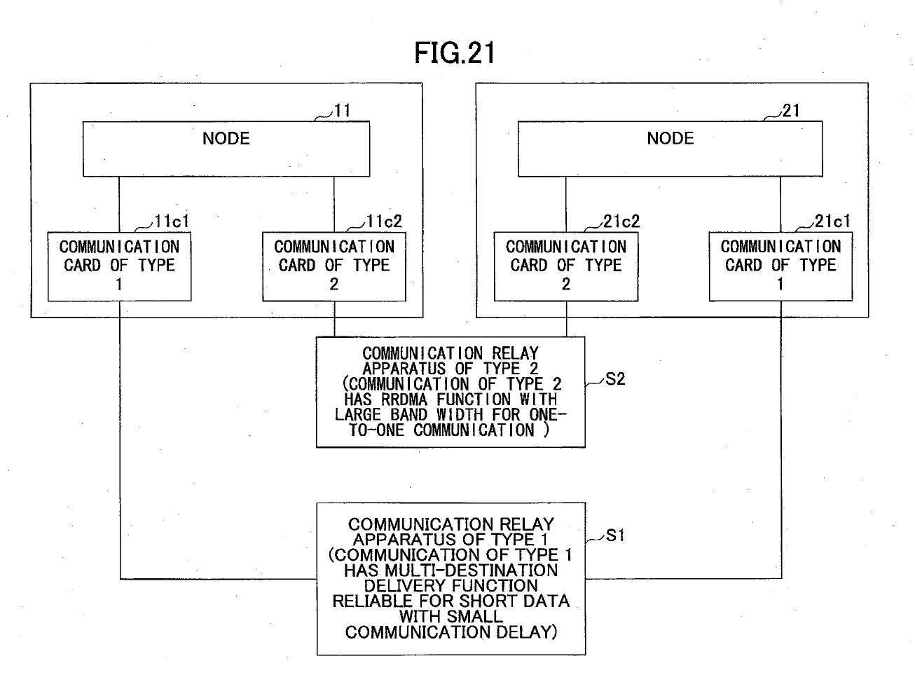

(3) In a case where a transfer capability of the entire network is a bottleneck, a plurality of networks are used. This method includes a method in which another type of a network is also used (described above using FIG. 21).

Specifically, as depicted in FIG. 19, the number of communication cards such as NICs is increased. In FIG. 19, the nodes 11, 21, 22 and 23 have two communication cards 11c1 and 11c2, 21c1 and 21c2, 22c1 and 22c2, and 23c1 and 23c2, respectively. Further, a communication relay apparatus S1 is provided for relaying among the nodes 11, 21, 22 and 23. As a result, it is possible to separate IO buses, and load sharing may be achieved.

In a case where nodes each having a plurality of communication cards are included in the system in a sufficient ratio, a node having the plurality of communication cards may be used as a relay server at a time of the relay in each relay stage of the hierarchical communication. In this case, load sharing (for avoiding contention) may be achieved as a result of the plurality of reception-side nodes receiving the transmission data indirectly by using the relay server that has the plurality of communication cards and thus has high network capability. FIG. 20 depicts an example in which a node N1 having a plurality of (3, in this example) communication cards N1c1, N1c2 and N1c3 is used as a relay server. In FIG. 20, a reception-side node 24 uses a communication card 24c of itself, and receives transmission data directly (or only via a communication relay apparatus S1 as depicted in FIG. 20) from a transmission-side node 11 having a communication card 11c. On the other hand, reception-side nodes 21, 22 and 23 having communication cards 21c, 22c and 23c, respectively, receive the transmission data from the transmission-side node 11 indirectly by using the node N1 as the relay server having the communication cards N1c1, N1c2 and N1c3 (or further using the communication relay apparatus S1). As a result, the load on the transfer source when the plurality of reception-side nodes 21, 22, 23 and 24 receive the transmission data are shared by the total 4 communication cards, i.e., the communication card 11c of the transmission-side node 11, and the communication cards N1c1, N1c2 and N1c3 of the node N1 as the relay server. Further, the node N1 as the relay server may use the three communication cards N1c1, N1c2 and N1c3 to receive the transmission data from the transmission-side node 11 in a manner of dividing into three sets of the transmission data. Thereby, the load on the communication card is shared by the three communication cards also at this time.

FIG. 21 depicts an example in which a plurality of networks (first and second networks) are used and load sharing (for avoiding contention) is achieved. In a case of FIG. 21, a first network has a communication relay apparatus S1 which supports the multi-destination delivery method reliable when the data is short, and thus, is used for a multi-destination delivery of buffer information in the communication method according to the first embodiment. That is, a transmission-side node 11 uses a communication card 11c1, and transmits the buffer information via the communication relay apparatus S1 of the first network. A reception-side node 21 uses a communication card 21c1, and receives the buffer information via the communication relay apparatus S1 of the first network. On the other hand, a second network has a communication relay apparatus S2 which supports the reliable one-to-one communication (the method using the RRDMA function or the like), and thus, is used for transfer of transmission data in the communication method according to the first embodiment. That is, the reception-side node 21 uses a communication card 21c2, and receives the transmission data from the communication card 11c2 of the transmission-side node 11 via the communication relay apparatus S2 of the second network.

(b) Plural nodes are used, and the plurality of nodes share a resource that is a bottleneck and process that uses the resource. In this case, scheduling of the process among the plurality of nodes is carried out, and a requested data transfer amount to be simultaneously processed by one node is reduced. Specifically, the following two methods (1) and (2) may be considered.

(1) In a case where the number of nodes is very large, the hierarchical processing is carried out by the following method.

In a case of a multi-destination delivery, the number of nodes that will have data, which only the transmission-side node has at a transmission start time, is increased as the number of the communication stages is increased. In other words, in the hierarchical relationship, as the stage approaches the reception-side nodes, the number of nodes that can act as transmission-side nodes in the next stage increases. By using this method, it is possible to distribute the load on various types of resources and avoid contention.

As the number of distributions in each stage of the hierarchical relationship is increased, the number of communication stages may be reduced, but the time period in each stage increases. Further, the load on a communication resource and a communication period of time related to the communication between two nodes depend on how to select the two nodes and the communication data amount.

(2) Which way is suitable to carry out transfer in each stage of the hierarchical communication in order to optimize the performance of the entire multi-destination delivery is determined in consideration of a ratio between the following constraints related to resources and a requested transfer amount, and/or a network connection configuration (topology):

A constraint by a communication band supported by each NIC, a band of a IO bus or a memory bus;

A constraint by a resource amount (the number of NICs, the number of buses that can operate independently) per node; and

A constraint by a resource amount on the side of a transmission method currently applied to a network (for example, a communication data amount that may be processed at a time by a switch or a hub included in the network has the upper limit, and therefore, the sum of data amounts currently moving in the network at a unit period time has the upper limit).

The above-mentioned methods (a) and (b) may be general methods (not necessarily depending on whether the RRDMA function is used) of load sharing (avoiding contention) related to resources other than CPU. In particular, even in a case where only one-to-one communication using the RRDMA function is used for moving a data body (transmission data), any method that may be used for realizing a multi-destination delivery by a combination of only one-to-one communication operations may be used as it is. Further, it is possible to use the above-mentioned methods (a) and (b) by using the buffer information used in the multi-destination delivery method reliable when the data is short and further expanding it. First, a method of avoiding contention that may occur when using the RRDMA function in the communication method according to the first embodiment will now be described.

Generally, in a case where a multi-destination delivery is realized by the hierarchical transfer, all the nodes that have received data in a previous stage transferring the received data to as many other nodes as possible in the next stage is the most efficient, from the viewpoint of the degree of parallelism of the transfer. Further, in a case where the following conditions (1) and (2) are satisfied (as approximations having sufficiently high accuracy), the actual multi-destination delivery performance is improved.

(1) Transfer periods of time between any two nodes are the same for all nodes.

(2) A plurality of sets of nodes simultaneously communicating do not affect the performance of communication between the respective sets of nodes.

In a multi-destination delivery in a real network, there are many cases where the above-mentioned conditions (1) and (2) are not satisfied, due to conditions of the topology of the network, characteristics of communication performance of nodes, transfer data amounts and so forth. Below, a case will be considered in which the above-mentioned guidance, i.e., all the nodes that have received data in a previous stage transferring the received data to as many other nodes as possible in the next stage has a meaning for a certain range, when improving the efficiency in a case where a multi-destination delivery is realized by the hierarchical transfer.

First, the simplest case is selected as a comparison reference, in which, in a case where a multi-destination delivery is realized by the hierarchical transfer using only one-to-one communication operations, all the nodes that have received data from single nodes in a previous stage transfer the received data to other single nodes, respectively, in the next stage. A transfer pattern in this case may be expressed by a graph called a binomial tree.

A case is assumed in which, when two nodes simultaneously receive data from a transfer source node using the RRDMA function, a time period equal to or more than double elapses in comparison to a case where, after the completion of data reception by the RRDMA function initiated by one node, data transfer initiated by the other node is started. Other than this case, higher performance may be realized by transferring to two nodes simultaneously in comparison to the above-mentioned transfer pattern of binomial tree.

The above described case in which two nodes simultaneously receive data from a transfer source node using the RRDMA function, a time period equal to or more than double elapses in comparison to a case in which, after the completion of data reception by the RRDMA function initiated by one node, data transfer initiated by the other node is started is, as described below, comparatively a rare case. Therefore, if this case occurs, it may be possible to eliminate the problem by reducing the load at a location that is a bottleneck.

(1) When two nodes simultaneously receive data from a transfer source node using the RRDMA function, periods of time for starting and finishing the transfer operation (including periods of time of processing by software) are the longer periods of time of the single transfer operation (for one node), since the transfer operations are carried out by the two reception-side nodes in parallel. However, in a case where, after the completion of a transfer operation initiated by one node, a transfer operation initiated by the other node is started, periods of time for starting and finishing the transfer operations are the sum of those two transfer operations. In a case of transfer of a comparatively small size of data, there is a case where periods of time for starting and finishing the transfer operation are similar to the period of time for the transfer operation itself (the periods of time for starting and finishing the transfer operation are not ignorable). Therefore, likelihood that the sum of the time periods of the two transfer operations becomes longer than the periods of time of the one transfer operation (the longer periods time) is high.

(2) As a cause of a transfer period of time in a case where two nodes simultaneously receive data by the RRDMA function from a transfer source node becoming longer than a case of accessing from only one node, the following point may be considered. That is, transfer periods of time of respective parts of data increase by periods of time of the arbitration carried out by hardware. In other words, this is a case where, as a result of two transfer destination nodes simultaneously accessing a transfer source node, an influence of reduction in bandwidths of a NIC, an IO bus, a memory and so forth becomes a dominant factor. Also considering the reason mentioned above in the item (1), the above-mentioned problematic case in which, when two nodes simultaneously receive data from a transfer source node using the RRDMA function, a time period equal to or more than double elapses in comparison to a case where, after the completion of data reception by the RRDMA function initiated by one node, data transfer initiated by the other node is started may be eliminated as follows. That is, by dealing with the constraint by the bandwidth for a case where a comparatively long size of data is transferred at a time, the problematic case may be eliminated.

For such a problematic case of parallel accessing, the above-mentioned method in which as to a system resource having a heavy load, the number thereof per node is increased, and the increased number of resources are operated in parallel may be advantageous. Further, no problem may occur when the number of transfer destinations is controlled to be equal to or less than the number of resources that may be operated in parallel.

(3) Considering the above item (2), a problem, if any, may occur in a case where because transfer data (transmission data) is long, a transfer period of time is determined by the communication bandwidth of a transfer source. In this case, the problem may be eliminated by dividing the data into a plurality of segments, and providing a plurality of nodes that act as transfer sources in each stage.

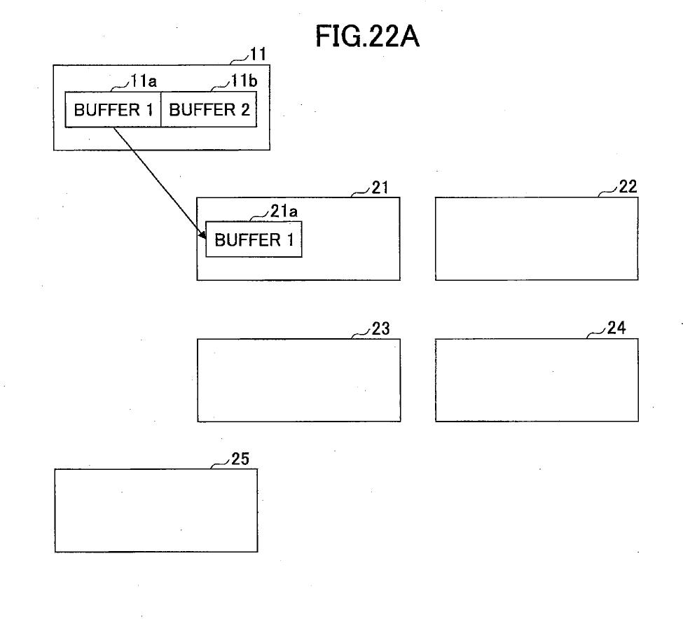

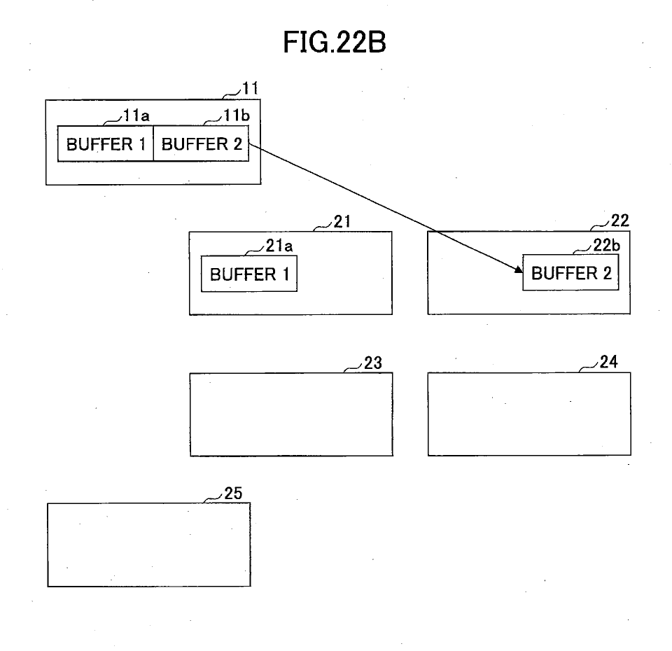

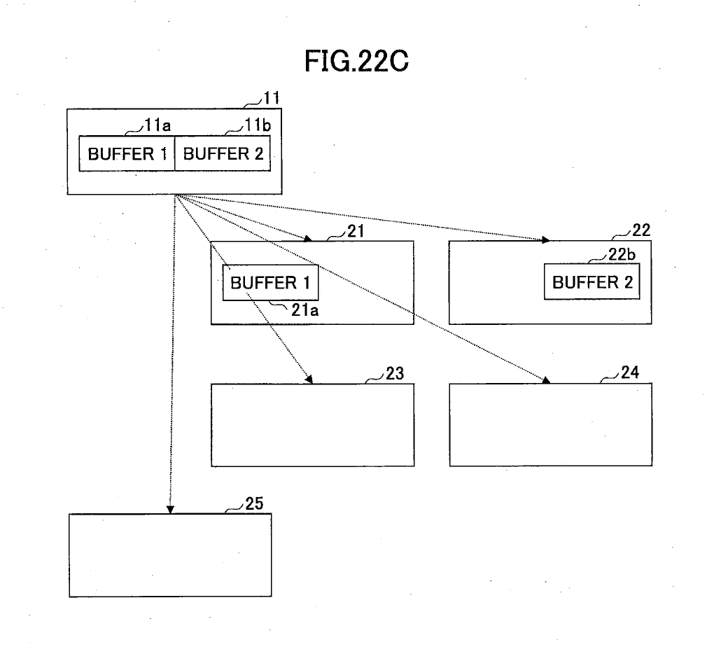

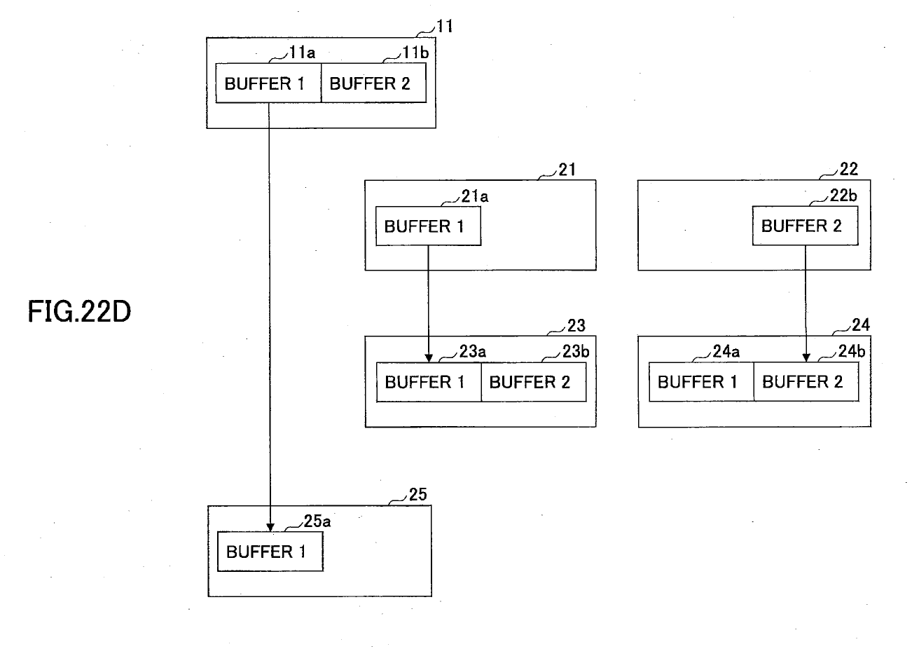

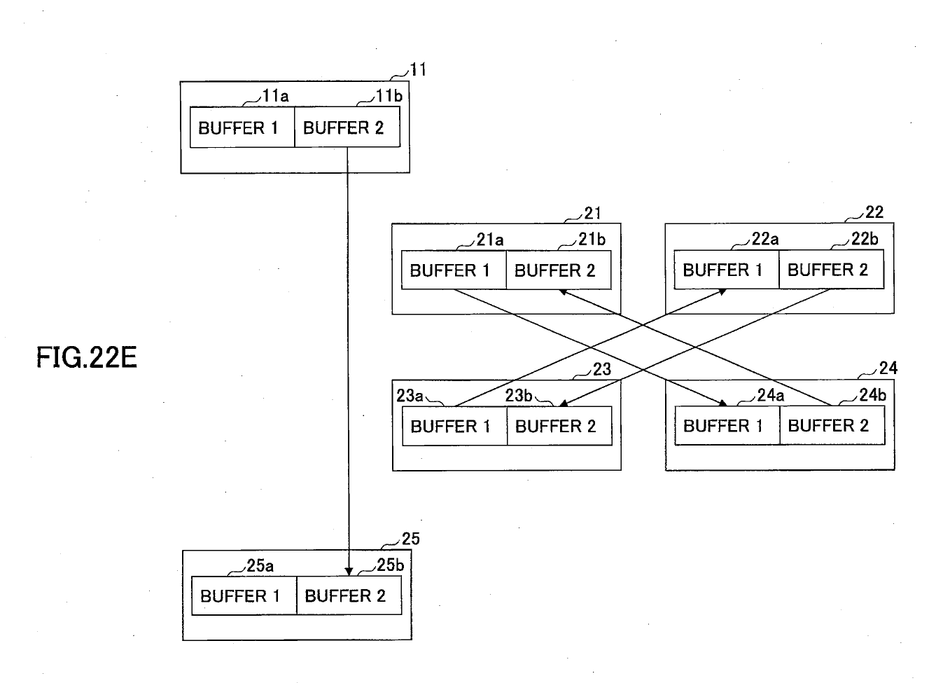

FIGS. 22A, 22B, 22C, 22D and 22E depict an example in which transmission data is divided into two segments (a first segment and a second segment), and servers are created as transfer sources of the respective segments. In this example, it is possible to avoid simultaneous execution of accessing one node from a plurality of nodes by the RRDMA function. For a fifth stage depicted in FIG. 22E to be described later, it is assumed that a transfer function of a communication card, which each of the reception-side nodes 21, 22, 23 and 24 has, has independent bandwidths for transmission and reception operations. Many NICs have such functions.

In a first stage depicted in FIG. 22A, the first segment of the transmission data is transferred from a communication buffer 11a of a transmission-side node 11 to a communication buffer 21a of a reception-side node 21, by the RRDMA function.

In a second stage depicted in FIG. 22B, the second segment of the transmission data is transferred from a communication buffer 11b of the transmission-side node 11 to a communication buffer 22b of a reception-side node 22, by the RRDMA function.

In a third stage depicted in FIG. 22C, the transmission-side node 11 transmits buffer information (to be used for execution of a fourth stage and the fifth stage, described below) to reception-side nodes 21, 22, 23, 24 and 25 by the multi-destination delivery method reliable when the data is short.

In the fourth stage depicted in FIG. 22D, the first segment of the transmission data is transferred from the communication buffer 11a of the transmission-side node 11 to a communication buffer 25a of the reception-side node 25 by the RRDMA function. Further, the first segment of the transmission data is transferred from the communication buffer 21a of the reception-side node 21 that also functions as a relay node, to a communication buffer 23a of the reception-side node 23 by the RRDMA function. Similarly, the second segment of the transmission data is transferred from the communication buffer 22b of the reception-side node 22 that also functions as a relay node, to a communication buffer 24b of the reception-side node 24 by the RRDMA function.

In the fifth stage depicted in FIG. 22E, the second segment of the transmission data is transferred from the communication buffer 11b of the transmission-side node 11 to a communication buffer 25b of the reception-side node 25 by the RRDMA function. Further, the first segment of the transmission data is transferred from the communication buffer 21a of the reception-side node 21 that also functions as a relay node, to a communication buffer 24a of the reception-side node 24 by the RRDMA function. Similarly, the second segment of the transmission data is transferred from the communication buffer 22b of the reception-side node 22 that also functions as a relay node, to a communication buffer 23b of the reception-side node 23 by the RRDMA function. Similarly, the first segment of the transmission data is transferred from the communication buffer 23a of the reception-side node 23 that also functions as a relay node, to a communication buffer 22a of the reception-side node 22 by the RRDMA function. Similarly, the second segment of the transmission data is transferred from the communication buffer 24b of the reception-side node 24 that also functions as a relay node, to a communication buffer 21b of the reception-side node 21 by the RRDMA function.

By the first through fifth stages described above using FIGS. 22A, 22B, 22C, 22D and 22E, the first segment and the second segment of the transmission data stored in the communication buffers 11a and 11b of the transmission-side node 11 are transferred to the reception-side nodes 21, 22, 23, 24 and 25. That is, the first and second segments of the transmission data are transferred to the communication buffers 21a, 21b of the reception-side node 21. Similarly, the first and second segments of the transmission data are transferred to the communication buffers 22a, 22b of the reception-side node 22. Similarly, the first and second segments of the transmission data are transferred to the communication buffers 23a, 23b of the reception-side node 23. Similarly, the first and second segments of the transmission data are transferred to the communication buffers 24a, 24b of the reception-side node 24. Similarly, the first and second segments of the transmission data are transferred to the communication buffers 25a, 25b of the reception-side node 25.

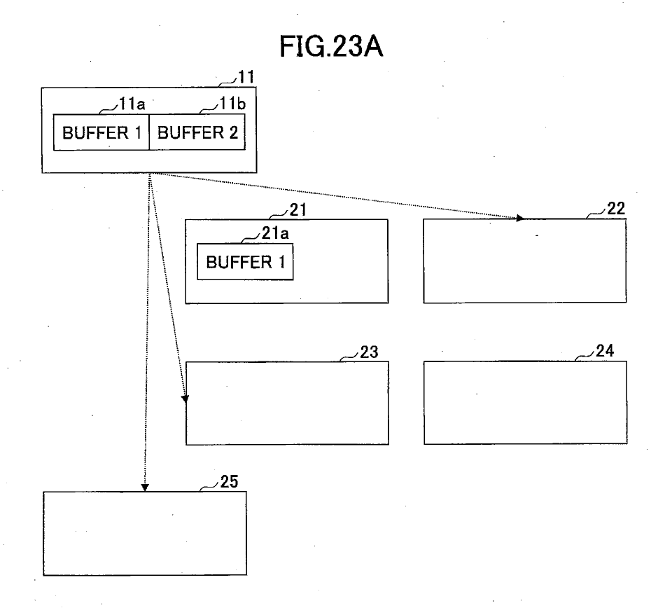

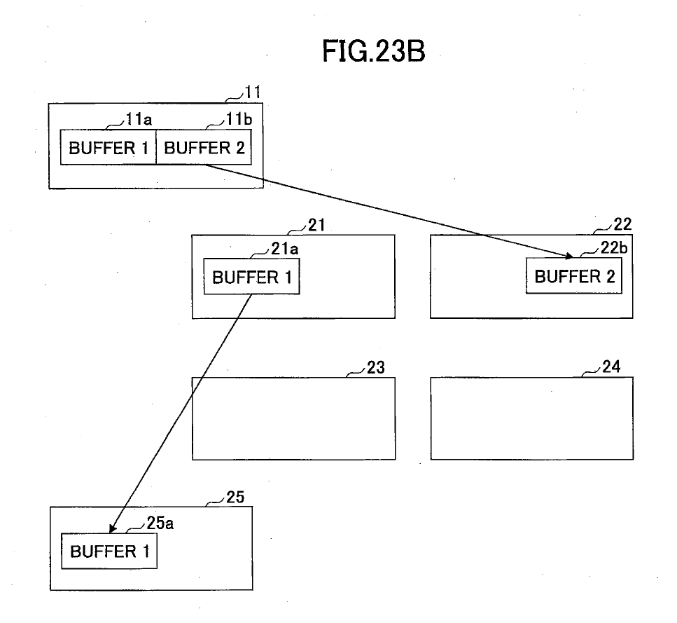

In the second stage of FIG. 22B, the node 21 that has already received the first segment of the transmission data does not act as a transfer source. An example described below using FIGS. 23A and 23B is a case in which, in the above-mentioned second stage, transfer is started from the node 21 that has already received the first segment of the transmission data. In consideration that a period of time for reporting the buffer information using the multi-destination delivery method reliable when the data is short is short since the data is short, the degree of parallelism of transfer of the communication cards in the plurality of nodes becomes higher by the method of the example of FIGS. 23A and 23B.

In the case of the example of FIGS. 23A and 23B, in the second stage, as depicted in FIG. 23A (after the first stage described above using FIG. 22A), the transmission-side node 11 transmits buffer information (according to the communication method of the first embodiment) to the reception-side nodes 22, 23 and 25 in a manner of a multi-destination delivery by the multi-destination delivery method reliable when the data is short.

Next, as depicted in FIG. 23B, based on the above-mentioned buffer information, the reception-side node 22 receives the second segment of the transmission data from the transmission-side node 11 using the RRDMA function. Further, based on the above-mentioned buffer information, the reception-side node 25 receives the first segment of the transmission data from the reception-side node 21 that also functions as a relay node, using the RRDMA function. After that, the third through fifth stages described above using FIGS. 22C, 22D and 22E are carried out. However, in the case of the example of FIGS. 23A and 23B, the first segment of the transmission data has already been transferred to the reception-side node 25 in the second stage. Therefore, in this case, it is not necessary to transfer the first segment of the transmission data to the reception-side node 25 again in the fourth stage.

Next, a method of avoiding the contention that may occur when the RRDMA function is used in a case of the communication method according to the second embodiment will be described.

In a case where the multi-destination delivery method not necessarily reliable when the data is long is used for transfer of a data body (transmission data) and the RRDMA function is used for a recovery of the transmission data, an amount of accessing from a plurality of nodes may be small. Therefore, problem of the contention is unlikely to occur. Further, the method (3) described above in the description of the method for avoiding contention at a time of using the RRDMA function in a case of the communication method according to the first embodiment may be also used in this case. That is, when the transmission data related to the retransmission is transferred, the transmission data related to the retransmission may be divided into a plurality of segments, and the reception-side nodes may obtain the respective segments of the transmission data via different nodes.

In a case where the multi-destination delivery method not necessarily reliable when the data is long is used, when the transmission data related to the retransmission is obtained (in particular, in a case where the number of nodes is large), instead of using a tree-like hierarchy, a method of obtaining the transmission data from a node that has properly obtained the transmission data in a preceding stage in a ring manner is also known. When the transfer pattern is like a ring, accessing is carried out from only one node at a time, and thus, the contention does not occur. For example, Torsten Hoefler, Christian Siebelt, and Wolfgang Rehm, “A Practically constant-time MPI Broadcast Algorithm for large-scale InfiniBand Clusters with Multicast”, FIG. 1, and so forth, describe this method.

FIG. 24 illustrates an example of setting the above-mentioned communication buffer.

In the case of the example of setting the communication buffer, in the main storage 500 that the node has, an area 520 having the starting address 521 is set as a buffer area. Further, in the buffer area 520, an area 525 having a length 523 starting from an address distant from the starting address 521 by an offset 522 is set as the communication buffer. That is, the communication buffer 525 has a range from the address obtained from “starting address”+“offset 522” to the address obtained from “starting address”+“offset 522”+“length 523”. As mentioned above, the buffer information is information indicating the location of the communication buffer. Therefore, in the case of the setting example of FIG. 24, the buffer information includes information of the above-mentioned starting address 521, the offset 522 and the length 523.

FIG. 25 illustrates an example of a data format of the above-mentioned recovery control information. In the example of a data format of FIG. 25, the data format of the recovery control information includes an area 310 storing an error detection code, an area 320 storing information indicating a size of data (transmission data), and an area 330 storing other information. In the area 330, in some cases, a timeout period, buffer information or the like is stored, as mentioned above.

Although the embodiments are numbered with, for example, “first,” or “second,” the ordinal numbers do not imply priorities of the embodiments. Many other variations and modifications will be apparent to those skilled in the art.

According to the embodiments described above, it is possible to positively carry out a multi-destination delivery of data that is shorter than the transmission data by the multi-destination delivery using the barrier synchronization. Hence, it is possible to positively transmit the buffer information to the plurality of reception-side nodes by the multi-destination delivery using the barrier synchronization. In addition, the plurality of reception-side nodes may positively receive the transmission data from the communication buffer by the one-to-one communication using the buffer information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that various changes, substitutions, and alterations could be made hereto without departing from the spirit and scope of the invention.

1. A communication method comprising:
storing, by a transmission-source node, transmission data to be transmitted to a plurality of transmission-destination nodes, in a communication buffer of the transmission-source node;
creating, by the transmission-source node, buffer information to be used by the plurality of transmission-destination nodes for receiving the transmission data from the communication buffer;
transmitting, by the transmission-source node, the buffer information to the plurality of transmission-destination nodes by a first communication method that makes a multi-destination delivery using a barrier synchronization in which the plurality of transmission-destination nodes are synchronized by receiving synchronization signals from each of the plurality of transmission-destination nodes; and
receiving, by the plurality of transmission-destination nodes, respectively, the transmission data from the communication buffer using the buffer information by a second communication method that makes a one-to-one communication.

2. The communication method as claimed in claim 1, wherein the first communication method uses the barrier synchronization or a reduction apparatus, as a communication method having reliability for transmission of data shorter than the transmission data.

3. The communication method as claimed in claim 1, wherein the second communication method uses a function of writing a value in a memory of a remote host without using a central processing unit.

4. An information processing apparatus comprising:
a storing unit configured to store transmission data to be transmitted to a plurality of transmission-destination nodes in a communication buffer;
a creating unit configured to create buffer information to be used by the plurality of transmission-destination nodes for receiving the transmission data from the communication buffer; and
a transmitting unit configured to transmit the buffer information to the plurality of transmission-destination nodes, by a first communication method that makes a multi-destination delivery using a barrier synchronization by receiving synchronization signals from the plurality of transmission-destination nodes.

5. The information processing apparatus as claimed in claim 4, wherein the first communication method uses the barrier synchronization or a reduction apparatus, as a communication method having reliability for transmission of data shorter than the transmission data.

6. An information processing apparatus comprising:
a first receiving unit configured to receive, from a transmission-source node, buffer information to be used for receiving transmission data from a buffer in which the transmission data is stored by the transmission-source node, by a first communication method that makes a multi-destination delivery; and
a second receiving unit configured to receive the transmission data from the buffer using the buffer information, by a second communication method that makes a one-to-one communication.

7. The information processing apparatus as claimed in claim 6, wherein the first communication method uses the barrier synchronization or a reduction apparatus, as a communication method having reliability for transmission of data shorter than the transmission data.

8. The information processing apparatus as claimed in claim 6, wherein the second communication method uses a function of directly writing a value in a memory of a remote host without using a central processing unit.

9. A non-transitory computer readable recording medium storing a program which, when executed by a computer of a transmission-source node, causes the computer to perform a process comprising:
storing transmission data to be transmitted to a plurality of transmission-destination nodes in a communication buffer of the transmission-source node;
creating buffer information to be used by the plurality of transmission-destination nodes for receiving the transmission data from the communication buffer; and
transmitting the buffer information to the plurality of transmission-destination nodes by a first communication method that makes a multi-destination delivery using a barrier synchronization in which the plurality of transmission-destination nodes are synchronized by receiving synchronization signals from each of the plurality of transmission-destination nodes.

10. The non-transitory computer readable recording medium as claimed in claim 9, wherein the first communication method uses the barrier synchronization or a reduction apparatus, as a communication method having reliability for transmission of data shorter than the transmission data.
